(19) United States
(12) Patent Application Publication
(10) Pub. No.: US 2026/0287928 A1
(43) Pub. Date: Sep. 24, 2026

(54) BINOCULAR LENSLETS DESIGNS FOR MYOPIA CONTROL

(71) Applicant: Essilor International, Charenton-Le-Pont (FR)

(72) Inventors: Matthieu GUILLOT, Issy Les Moulineaux (FR); Guillaume GIRAUDET, Orleans (FR)

(73) Assignee: Essilor International, Charenton-Le-Pont (FR)

(21) Appl. No.: 19/136,538

(22) PCT Filed: Dec. 6, 2023
(86) PCT No.: PCT/EP2023/084491

§ 371 Date: Jun. 6, 2025

(30) Foreign Application Priority Data
Dec. 7, 2022 (EP) 22306808

(51) Int. Cl. G02C 7/02; G02C 7/06

(52) U.S. Cl. CPC G02C 7/022; G02C 7/066; G02C 2202/20; G02C 2202/24

(57) ABSTRACT

A pair of spectacle lenses for managing myopia progression comprising a first optical lens intended to be worn in front of a first eye of a wearer and a second optical lens intended to be worn in front of a second eye of the wearer, in which:—the first optical lens comprising an arrangement of micro-optical elements having, and—the second optical lens comprising an arrangement of micro-optical elements having, wherein the arrangement of micro-optical elements of the first optical lens and the arrangement of the micro-optical elements of the second optical lens are asymmetrical relatively to a sagittal plane of the pair of spectacle lenses.

### TECHNICAL FIELD OF THE INVENTION

The invention relates to a pair of spectacle lenses for reducing the myopia progression comprising a first optical lens intended to be worn in front of a first eye of a wearer and a second optical lens intended to be worn in front of a second eye of the wearer, in which the first and second lenses have each an arrangement of micro-optical elements to induce blur. It also refers to vision compensation spectacles comprising a frame, a first optical lens intended to be worn in front of a first eye of a wearer and a second optical lens intended to be worn in front of a second eye of the wearer, in which the first and second lenses have each an arrangement of micro-optical elements.

More precisely the invention relates to a pair of spectacle lenses with a specific design to induce a specific blur or defocus effect.

### BACKGROUND INFORMATION AND PRIOR ART

Myopia of an eye is characterized by the fact that the eye focuses light coming from far distance in front of the retina. In other words, a myopic eye presents a length that is not suitable for clear vision. Myopia has both genetic and environmental origins. In the latter case, it develops due for instance to the increase in near vision tasks, but also to less outdoor activities.

Many solutions exist that aim at reducing myopia evolution. For example, it is known to use a pair of lenses each arranged to be worn in front of one eye of a subject and having micro-optical elements configured to induce blur in peripheral vision areas while enabling sharp vision in the foveal area of the eye. These solutions are functional but do not distinguish the specificities of the two eyes, such as the dominant eye, and consequently the design of these lenses is not well adapted to the specificities of each eye. In addition, in these solutions, the visual acuity of the subject could be altered because of the non-consideration of all the specificities of each eye of the subject.

### SUMMARY OF THE INVENTION

In this context, one object of the invention is to provide a solution able to manage the myopia evolution binocularly with a better tradeoff between visual acuity and myopia evolution control.

The above objects are achieved according to the invention by providing a pair of spectacle lenses comprising a first optical lens intended to be worn in front of a first eye of a wearer and a second optical lens intended to be worn in front of a second eye of the wearer, in which:
the first optical lens comprising an arrangement of micro-optical elements and
the second optical lens comprising an arrangement of micro-optical elements,

the arrangement of the micro-optical elements of the first optical lens and the arrangement of the micro-optical elements of the second optical lens are asymmetrical relatively to a sagittal plane of the pair of the spectacle lenses.

In other words, the arrangement of optical elements of the first lens and the arrangement of the optical elements of the second lens present a difference in a symmetrical area of the first lens and of the second lens, the symmetrical area of the first lens being symmetric with the symmetrical area of the second lens relatively to the sagittal plane of the pair of the spectacle lens.

Thanks to the optical design of the first and second lens, the pair of spectacle lenses accounts for the specificities of the two eyes, such as the dominant eye. Specifically, the design of each eye is adapted to the dominant eye or the non-dominant each. Consequently, the pair of spectacle lenses presents a good tradeoff between visual acuity and myopia discomfort and evolution control, said myopia discomfort and myopia evolution being managed binocularly with the specific optical design of the first and second lenses.

According to an embodiment, the sagittal plane of the pair of the spectacle lenses passes at equal distance between the first lens and the second lens.

According to an embodiment, the arrangement of the micro-optical elements of the first optical lens differs from the arrangement of the micro-optical elements of the second optical lens by at least one of the following criteria:
density of the micro-optical elements;
dioptric power of the micro-optical elements;
geometry of the micro-optical elements;
refractive, diffractive or diffusive optical function of the micro-optical elements;
focal length of the micro-optical elements;
diameter of the micro-optical elements;
position of the arrangement of the micro-optical elements in a visual field of the first optical lens and of the second optical lens;
position of the micro-optical elements in the arrangement of the micro-optical elements

According to an embodiment, at least one of the first and second optical lenses comprises a central zone with micro-optical elements.

According to an embodiment, at least one of the first and second optical lenses comprises a central zone without any micro-optical element.

According to an embodiment, the arrangement of micro-optical elements of at least one of the first and second optical lenses comprises a plurality of rings of micro-optical elements having growing diameters around the central zone.

According to an embodiment, the arrangement of micro-optical elements of at least one of the first and second optical lenses comprises at least one arc of circle centered on the central zone.

According to an embodiment, the first optical lens and the second optical lens are each divided in at least three complementary zones, the central zone, a first zone and a second zone, the arrangement of the micro-optical elements of the first zone of the first optical lens differing from the arrangement of the micro-optical elements of the second zone of the first optical lens and the arrangement of the micro-optical elements of the first zone of the second optical lens differing from the arrangement of the micro-optical elements of the second zone of the second optical lens, the arrangement of the micro-optical elements in first zone of the first optical lens being symmetric with the arrangement of the micro-optical elements in the first zone of the second optical lens by rotation of 180 degrees about an axis passing through the sagittal plane of the pair of spectacle lenses and perpendicular to a mean plane of the pair of spectacle lenses.

According to another embodiment, the first optical lens and the second optical lens are each divided in five complementary zones, the central zone, and four quadrants at 45 degrees defining respectively first, second, third and fourth zones, the arrangement of the micro-optical elements of the first zone of the first optical lens differing from the arrangement of the micro-optical elements of the second, third and fourth zones of the first optical lens and the arrangement the micro-optical elements of the first zone of the second optical lens differing from the arrangement of the micro-optical elements of the second, third and fourth zones of the second optical lens, the arrangements of the micro-optical elements in the first and second zones of the first optical lens being symmetric with the respective arrangements of the micro-optical elements in the first and second zones of the second lens by rotation of 180 degrees about an axis passing through the sagittal plane of the pair of spectacle lenses and perpendicular to a mean plane of the pair of spectacle lenses.

Typically, the arrangement of the micro-optical elements of the second zone of the first optical lens differs from the arrangement of the micro-optical elements of the third and fourth zones of the first optical lens, and the arrangement of the micro-optical elements of the second zone of the second optical lens differs from the arrangement of the micro-optical elements of the third and fourth zones of the second optical lens.

According to a further aspect, the arrangement of the micro-optical elements of the third zone of the first optical lens is similar to the arrangement of the micro-optical elements of the fourth zone of the first optical lens and the arrangement of the micro-optical elements of the third zone of the second optical lens is similar to the arrangement of the micro-optical elements of the fourth zone of the second optical lens.

Advantageously, the micro-optical elements of at least one of the first and second optical lenses are contiguous.

According to a further aspect, the arrangements of the micro-optical elements of the optical lenses are configured such that the first optical lens and the second optical lens each complies to an optical criterion based on the Modulation Transfer Function.

Advantageously, the optical criterion of the first optical lens differs from the optical criterion of the second optical lens, for example, in different ranges of spatial frequencies comprised between 1 and 7 cycles per degree and/or between 10 and 20 cycles per degree and/or between 20 and 30 cycles per degree.

Advantageously, the first optical lens and second optical lens comprise each an optical axis and horizontal and vertical axis both transverse to the optical axis, at least one optical criterion of the optical criteria of the first optical lens and second optical lens presents a variation along the horizontal axis and a variation along the vertical axis, said variation along the vertical axis differing from the variation along the horizontal axis.

According toa particular and advantageous aspect, the arrangement of the micro-optical elements of at least one of the first and second optical lenses comprises the following: refractive, diffractive or diffusing microlenses, Pi-Fresnel microlenses, microprisms, micro-diffusers, micro-diffraction gratings, scattering dots, Fresnel or toroidal structures.

According to a particular and advantageous aspect, the arrangement of the micro-optical elements of the first and second optical lenses are adapted based on the dominant eye of the wearer.

According to a particular and advantageous aspect, at least one of the optical lenses has at least one prescribed refractive power to provide a dioptric correction for the eye of the wearer.

The invention further relates to vision compensation spectacles for managing myopia progression comprising a frame and a pair of spectacle lenses as disclosed above.

### DETAILED DESCRIPTION OF EXAMPLE(S)

The following description with reference to the accompanying drawings will make it clear what the invention consists of and how it can be achieved. The invention is not limited to the embodiment/s illustrated in the drawings. Accordingly, it should be understood that where features mentioned in the claims are followed by reference signs, such signs are included solely for the purpose of enhancing the intelligibility of the claims and are in no way limiting on the scope of the claims.

In the accompanying drawings:

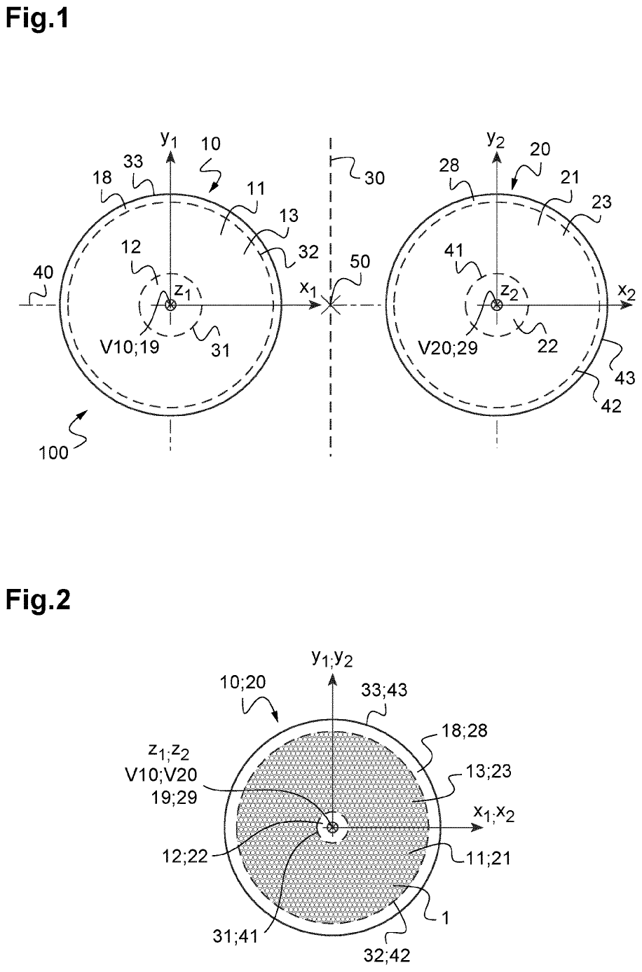

FIG. 1 shows a schematic front view of a first embodiment of a pair of spectacle lenses according to the present disclosure;

FIG. 2 shows a schematic front view of a first example of an arrangement of micro-optical elements on a lens according to the present disclosure;

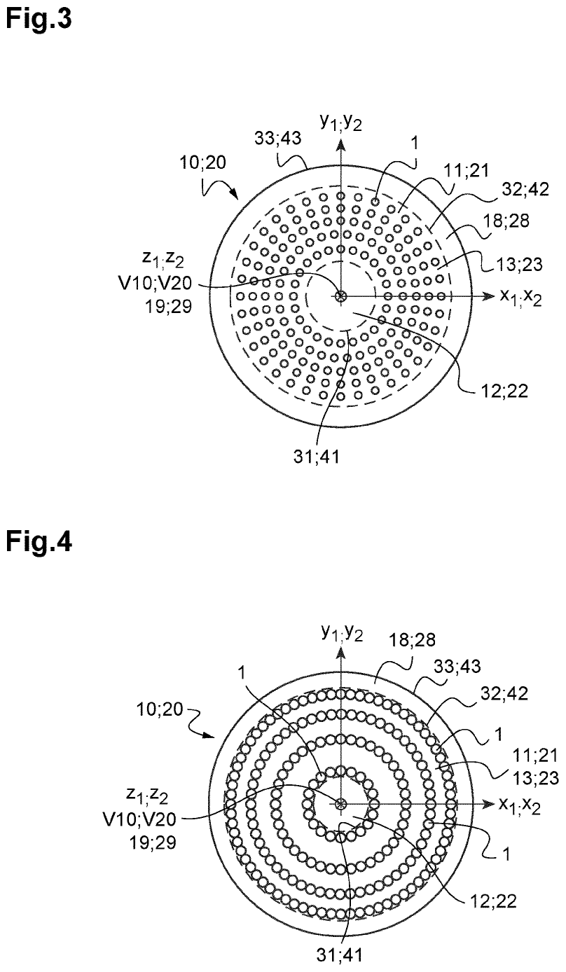

FIG. 3 shows a schematic front view of a second example of an arrangement of micro-optical elements on a lens according to the present disclosure;

FIG. 4 shows a schematic front view of a third example of an arrangement of micro-optical elements on a lens according to the present disclosure;

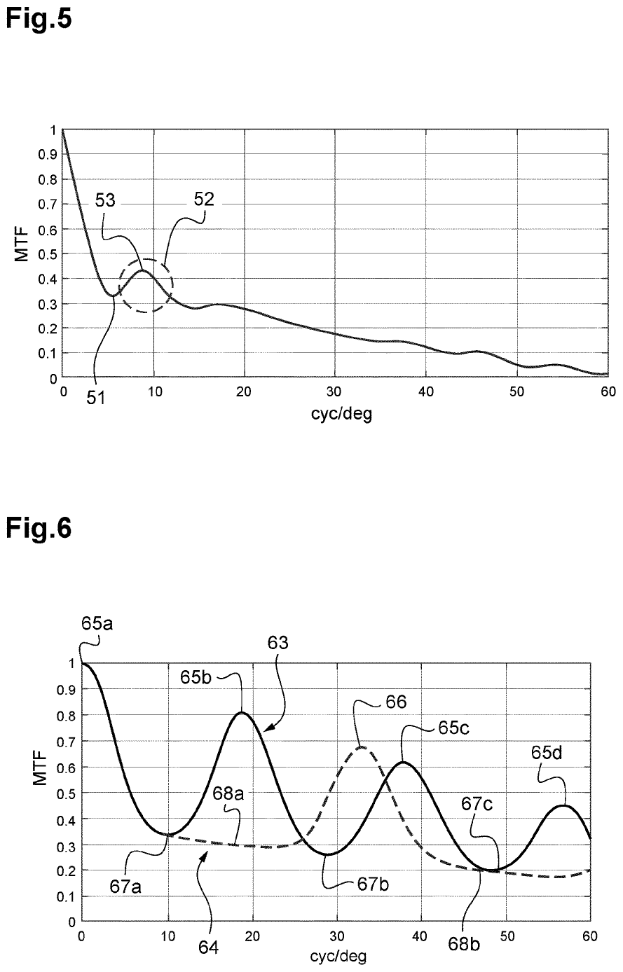

FIG. 5 shows a Modulation Transfer Function of the first optical lens of the first embodiment of the pair of spectacle lenses illustrated on FIG. 1;

FIG. 6 shows a Modulation Transfer Function of the second lens of the first embodiment of the pair of spectacle lenses illustrated on FIG. 1;

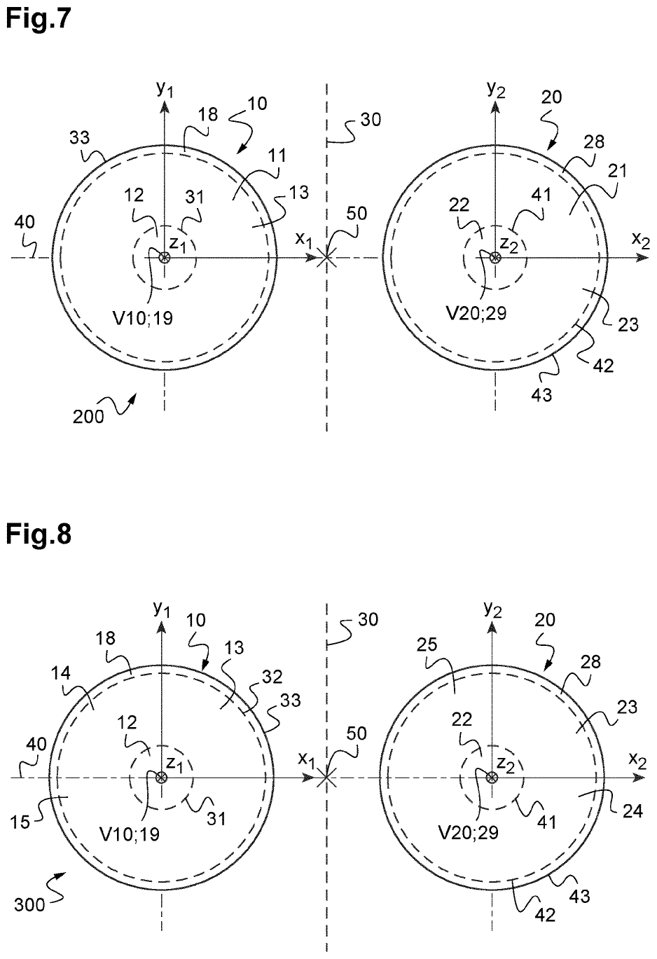

FIG. 7 shows a schematic front view of a second embodiment of a pair of spectacle lenses according to the present disclosure;

FIG. 8 shows a schematic front view of a third embodiment of a pair of spectacle lenses according to the present disclosure;

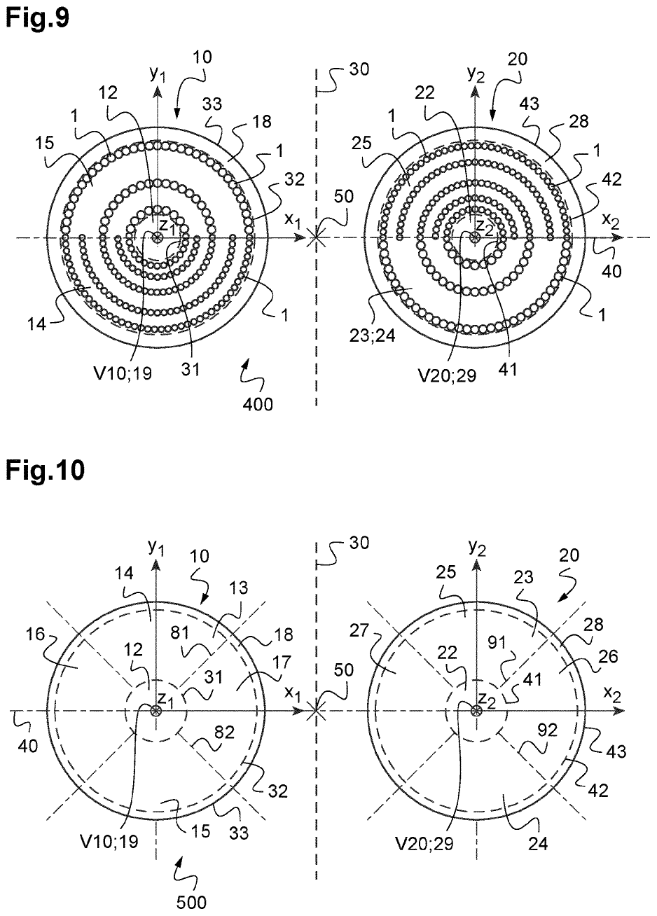

FIG. 9 shows a schematic front view of an example of an arrangement of micro-optical elements of the third embodiment of the pair of spectacle lenses according to the present disclosure;

FIG. 10 shows a schematic front view of a fourth embodiment of a pair of spectacle lenses according to the present disclosure;

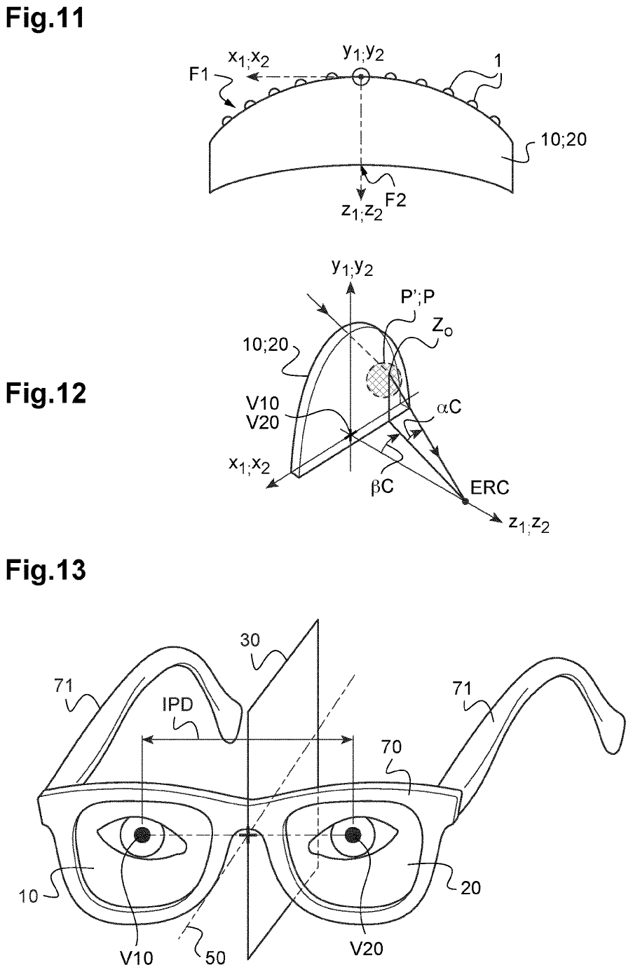

FIG. 11 shows a schematic cut view of an example of a first optical lens or second optical lens according to the present disclosure;

FIG. 12 shows a schematic view of an example of a first optical lens or second optical lens according to the present disclosure;

FIG. 13 shows a schematic view of a pair of spectacle lenses according to the present disclosure mounted on a frame;

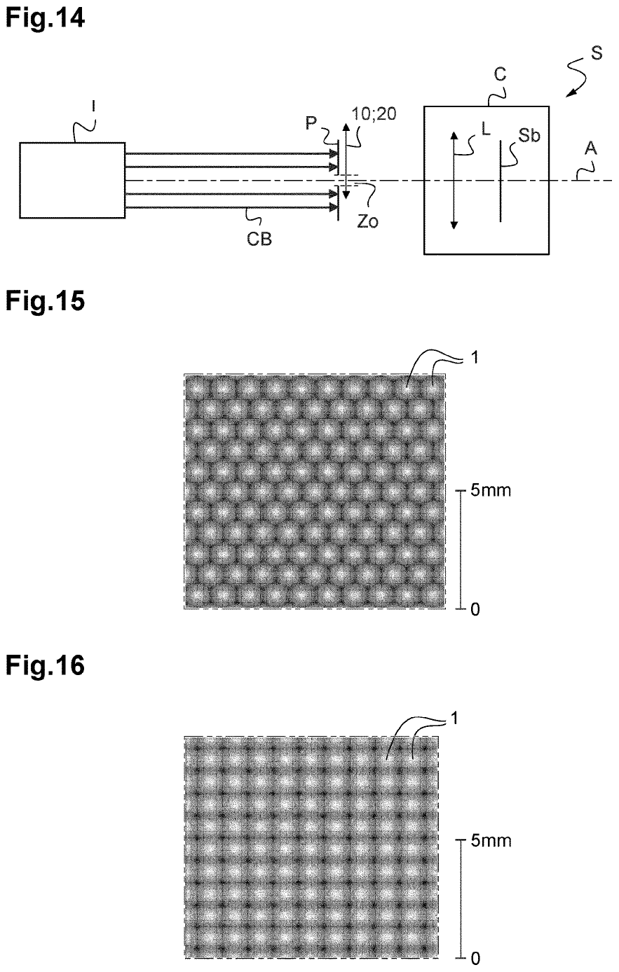

FIG. 14 shows a schematic view of a system used to measure the modulation transfer shown on FIGS. 5 and 6;

FIG. 15 shows an expanded view of another example of an arrangement of micro-optical elements on a lens according to the present disclosure;

FIG. 16 shows an expanded view of another example of an arrangement of micro-optical elements on a lens according to the present disclosure.

In the description, terms like, «horizontal», «vertical», «above», «below», «front», «rear», «left», «right» or other words indicating relative position may be used. These terms are to be understood in the wearing conditions of the pair of spectacle lenses according to the present disclosure.

### Definition

FIG. 12 is an illustration of the upper half of a first lens 10 and a first eye of the wearer or of the upper half of a second lens 20 and a second eye of the wearer showing the definitions used in the description.

On FIG. 12, the first lens 10 is positioned in front of the first eye or, respectively, the second lens 20 is positioned in front of the second eye of the wearer.

At least one of the first lens and second lens has at least one prescribed refractive power to provide a dioptric correction for the corresponding eye of the wearer.

In the following examples, the first lens 10 comprises an ophthalmic lens center V10 and, respectively the second lens 20 comprises an ophthalmic lens center V20. The ophthalmic lens center may be the optical or the geometrical center of the ophthalmic lens. The rear surface of first or second lens 10, 20 is the surface of the first or second lens 10, 20 closest to the wearer's eye.

The segment that links ophthalmic lens center V10 of the first lens to the ophthalmic lens center V20 of the second lens 20 is generally equal to the interpupillary distance (IPD).

A central vision gaze direction is defined by two angles (αC, βC) representing the eye rotation from a primary gaze direction. More precisely, the angles βC and αC represent respectively the horizontal and vertical rotation angles applied at the eye rotation center ERC in a Fick system to move the eye from the primary gaze reference axes to the eye gaze axes. A third torsional rotation of the eye derived from these two angles is applied so that the eye gaze axes respect Listing law. FIG. 12 illustrates an example for the angles αC and βC with respect to the eye rotation center ERC and the first lens 10. The central vision gaze direction can be represented by a line passing through the eye rotation center ERC.

The angle αC is defined in the vertical plane passing through the eye rotation center ERC, while the angle βC is defined in the horizontal plane passing through the eye rotation center ERC. The angle αC is defined as positive when the wearer's eye looks down and negative when the wearer's eye looks up. The angle βC is defined as positive when the wearer's eye looks to the nasal side and negative when the wearer's eye looks to the temporal side. The pantoscopic angle is the angle in the vertical plane between the normal to the rear surface of the first or second optical lens 10, 20 and the visual axis of the eye (axis z₁, z₂) in the primary position, defined as a horizontal direction, when the wearer gazes straight ahead at infinity.

The cornea to lens distance is the distance along the visual axis of the eye in the primary position between the cornea and the rear surface of the first or second lens 10, 20.

FIG. 13 shows the first lens 10 and the second lens 20 mounted on a frame 70 of vision compensation spectacles. The frame 70 comprises temples 71. In the present document, a sagittal plane 30 of the spectacles is defined as a plane passing at equal distance from the vertical sides of the two rectangular boxes wherein the first and second lenses are inscribed when mounted in the frame 70. Usually, when the wearer wears the pair of spectacle lenses in front of his eyes, the sagittal plane 30 of the spectacles is merged with the sagittal plane of the wearer. A mean plane of the pair of spectacle lenses is herein defined as the plane situated at a minimum distance from the rear surfaces of the two lenses 10, 20. We define an axis 50 passing through the sagittal plane 30 of the pair of spectacle lenses and perpendicular to the mean plane of the pair of spectacle lenses. A secondary axis 40 of the spectacle lenses is herein defined as the axis passing through the ophthalmic lens center V10, V20 of the two lenses 10, 20 and transverse to the sagittal plane 30. Of course, when the first 10 and second 20 lenses are mounted on the frame 70, the sagittal plane 30 of the pair of spectacle lenses corresponds to the sagittal plane of the wearer.

The wording sagittal plane of the wearer refers to the median plane of the segment whose ends are the centers of rotation of the eyes.

In the present disclosure, the sagittal plane of the spectacles is aligned with the sagittal plane of the wearer.

The wrap angle of the lens frame 70 is the angle in the horizontal plane between the normal to the rear surface of the first lens or second lens and the visual axis of the eye in the primary position.

The inter-pupillary distance, denoted IPD, is the distance between the centers of the pupils of the two eyes of a wearer in the primary position, when the eyes gaze directions are not converging, for example when looking at infinity along a horizontal line in the sagittal plane of the wearer with his head in a straight posture (See FIG. 13).

In the present application, a micro-optical element refers to various types of micro-optical elements, each micro-optical element being made with rather small dimensions of e.g. less than 2.5 mm. A micro-optical element comprises for example a lens, a Pi-Fresnel lens, a prism, a diffuser, a beam-splitter or a diffraction grating. The term micro-optical elements refer to a set of a number of similar micro-optical elements, comprising between about ten micro-optical elements and hundreds or thousands of micro-optical elements, depending on their individual size and depending on the various arrangements. The micro-optical elements are generally formed by photolithography, holography, molding, machining or encapsulation.

In the following, a pair of spectacle lenses is arranged for controlling the myopia progression.

### Device

A first embodiment of a pair of spectacle lenses 100 according to the present disclosure is described in relation with FIGS. 1 to 4 and FIG. 11.

The pair of spectacle lenses 100 on FIG. 1 comprises a first optical lens 10 and a second optical lens 20.

The first optical lens 10 is intended to be disposed in front of a first eye of a wearer and the second optical lens 20 is lens intended to be disposed in front of a second eye of the wearer. The first eye refers, for example, to the left eye of the wearer, whereas the second eye refers to the right eye of the wearer.

In the following, the first optical lens 10 is called first lens 10 and the second optical lens 20 is called second lens 20.

FIG. 11 shows an example of the first optical lens 10 or second optical lens 20. The first lens 10 or the second lens 20 is here a biconvex lens but could alternatively be a concavo-convex lens or a plano-convex lens.

The first 10 or second 20 lens illustrated on FIG. 11 has two opposite optical faces, a front face F1 directed towards an object side and a rear face F2 that is closest to the eye of the wearer. The first 10 or second lens 20 presents a center V10, V20, which is typically the optical or geometrical center of the first 10 or second 20 lens. In the present disclosure, the first lens 10 is defined with a first orthogonal frame of reference (V10, x₁, y₁, z₁) and the second lens 20 is defined with a second orthogonal frame of reference (V20, x₁, y₁, z₁) as illustrated by FIGS. 1 and 11.

The first lens 10 has an optical design comprising a macro-optical component and a micro-optical component.

The micro-optical component of the optical design (also referred to as “micro-optical design”) of the first lens 10 is made of several micro-optical elements 1 arranged on at least one of the front and rear faces of the first lens 10, preferably the convex front face.

The macro-optical component of the optical design of the first lens 10 (also referred to as “macro-optical design”) provides a macro-optical function providing at least one global refractive power over most or all the useful surface area of the first lens 10, to provide the wearer's eye a dioptric correction adapted to the dioptric correction need of the wearer in wearing conditions. Thus, the macro-optical component of the first lens 10 has at least one predetermined refractive power to provide a first dioptric correction for the first eye of the wearer. For example, this macro-optical function is provided by the geometry of the front face F1 or of the rear face F2 or of both faces, typically by adapting the curvature radii of one or both faces of the first lens 10. The refractive power of the first lens 10 is generally comprised between ±0.25 and ±15 diopters.

The global refractive power provided by the macro-optical design of the first lens 10 comprises at least a spherical power and/or a cylindrical power, a prismatic deviation power, according to the wearer's correction need determined by an eye care professional in order to correct the vision defects of the wearer. Typically, the global refractive power corresponds to the dioptric correction based on a prescription of the wearer, for example in standard wearing conditions. For example, the prescription for an ametropic wearer comprises the values of optical power and/or of astigmatism comprising a cylinder and an axis for distance vision and/or for near vision. Preferably, the global refractive power of the first lens 10 comprises a sphero-toroidal power.

The term “prescription” is to be understood to mean a set of characteristics of optical power, of astigmatism (for example of the type sphere S, cylinder C and axis A), and/or of prismatic deviation, determined by an eye care practitioner in order to correct the vision defects of the wearer. For example, the prescription for an ametropic wearer comprises the values of optical power and of astigmatism (S, C, A) for distance vision and/or for near vision.

The wearing conditions are to be understood as the position of the first lens 10 and the second lens 20 in the frame 70 worn by the wearer with respect to the eyes of the wearer. The wearing conditions are in the following defined according to the physiological parameters or the parameters of the frame 70 when the frame 70 is worn by the wearer. For example, the wearing conditions comprise for example a pantoscopic angle, a cornea to lens distance, a pupil to cornea distance, an eye rotation center (ERC) to pupil distance and a wrap angle.

An example of standard wearing conditions may be defined by a pantoscopic angle of −8° for an adult or between 0° and 5° for a child, a cornea to lens distance of 12 mm, a pupil to cornea distance of 2 mm, an ERC to pupil distance of 11.5 mm and a wrap angle of 0°.

Each micro-optical element 1 has its own optical function and has small dimensions of less than 2 mm, preferably less than 1 mm. Each micro-optical element 1 consists for example of a microlens, a Pi-Fresnel lens, a prism, a diffuser, a beam-splitter or a diffraction grating. The micro-optical elements are typically formed by photolithography, holography, molding, machining or encapsulation.

The micro-optical elements 1 of the first lens 10 form an arrangement 11 of micro-optical elements.

This arrangement 11 of all the micro-optical elements provides a micro-optical function which is distinct from and adds on the macro-optical function of the first lens 10. Thus, the global optical function of the first lens 10 is the addition of its macro-optical function and of its micro-optical function respectively provided by the macro-optical and micro-optical components of the optical design of the first lens 10. The micro-optical function of the first lens 10 is the optical function provided by the first lens 10 without its macro-optical design, that is without any global refractive power over most or all the useful surface area of the first lens 10. The macro-optical function of the first lens 10 is the optical function provided by the first lens 10 without its micro-optical design, that is without any micro-optical element.

Similarly, the second lens 20 has an optical design comprising a macro-optical component and a micro-optical component as explained above.

Preferably, the global refractive power of the second lens 20 comprises a sphero-toroidal power.

The micro-optical elements 1 of the second lens 20 form an arrangement 21 of micro-optical elements.

This arrangement 21 of all the micro-optical elements provides a micro-optical function which is distinct from and adds on the macro-optical function of the second lens 20. Thus, the total optical function of the second lens 20 is the addition of its macro-optical function and of its micro-optical function respectively provided by the macro-optical and micro-optical components of the optical design of the second lens 20. The micro-optical function of the second lens 20 is the optical function provided by the second lens 20 without its macro-optical design, that is without any global refractive power over most or all the useful surface area of the second lens 20. The macro-optical function of the second lens 20 is the optical function provided by the second lens 20 without its micro-optical design, that is without any micro-optical element.

The arrangement 11 of micro-optical elements 1 of the first lens 10 has features and the arrangement 21 of micro-optical elements of the second lens 20 has features.

Typically, the arrangement 11 of the micro-optical elements of the first lens 10 and the arrangement 21 of the micro-optical elements of the second lens 20 depend on the following features:
shape of the micro-optical elements;
density of the micro-optical elements or number or quantity of micro-optical elements in each arrangement of optical element;
dioptric power of the micro-optical elements;
geometry of the micro-optical elements;
refractive, diffractive or diffusive optical function of the micro-optical elements;
type of micro-optical elements: refractive, diffractive or diffusing microlenses, Pi-Fresnel microlenses, diffraction grating monofocal, bifocal, multifocal microlenses, scattering dots, Fresnel or toroidal structures;
focal length of the micro-optical elements;
size or diameter of the micro-optical elements;
position of the arrangement of micro-optical elements in a visual field of the first lens and of the second lens;
position of the micro-optical elements in each arrangement of micro-optical elements;
geometrical or random structure of each arrangement of micro-optical elements.

To this end, the features stated above comprise optical features of the micro-optical elements. Typically, the optical features of each micro-optical element comprise at least one of the following parameters: a dioptric power, a refractive, a diffractive or a diffusive optical function, a focal length, a diameter, a geometry of the micro-optical element.

In the present disclosure, each micro-optical element belonging to the arrangement 11 of the first lens 10 or to the arrangement of the second lens 20 has a size comprised between 0.1 and 2.5 millimeters and a surface shape, for example a spherical, or aspherical, or toroidal surface shape.

Each micro-optical element provides a refractive, diffractive or diffusive function.

In an embodiment, a part or all of the micro-optical elements of the arrangement 11 of the first lens 10 or of the arrangement 21 of the second lens 20 are refractive micro-optical elements. Each refractive micro-optical element of the arrangement 11 of the first lens 10 or of the arrangement 21 of the second lens 20 can comprise a monofocal or a bifocal spherical dioptric power.

A refractive micro-optical element can be a monofocal or a bifocal micro-optical element.

For example, the refractive micro-optical elements comprise refractive bifocal micro-optical elements with a spherical or aspherical shape.

A diffractive micro-optical element comprises for example a diffractive Pi-Fresnel micro-optical element. A diffractive Pi-Fresnel micro-optical element has a phase function, which presents TT phase jumps at the nominal wavelength Ao. The wavelength 20 is considered to be 550 nm for human eye vision applications. The diffractive Pi-Fresnel micro-optical element presents an optical axis perpendicular to its faces and passing through the optical center of the micro-optical element. The arrangement of micro-optical elements with diffractive Pi-Fresnel micro-optical elements mainly diffracts in two diffraction orders associated with two dioptric powers P₀(λ₀) and P₁(λ₀). Thus, when receiving collimated light, the micro-optical elements concentrate light on two distinct areas on their axis. Typically, the dioptric power P₁(λ₀) may have a spherical or an aspherical function for the “+1” diffraction order and the dioptric power P₀(λ₀) may have a spherical or an aspherical function for the zero-diffraction order.

For example, the dioptric power P₀(λ₀) is comprised in a range of +/−0.12 diopter in addition to a spherical power of the predetermined refractive power of the first lens or the second lens, deriving for example from a prescription for the wearer. According to an embodiment, the dioptric power P₁(λ₀) is comprised in absolute value between 1 diopter and 10 diopters. Preferably, the dioptric power P₁(λ₀) is comprised between ±2 diopters and ±6 diopters.

A diffusive micro-optical element has a diffusive optical function. It means that the diffusive optical element is configured to scatter light. For example, a collimated light is scattered in a cone with an apex angle ranging from +/−1° to +/−40°. In an example, the diffusive micro-optical elements are arranged to scatter light locally, i.e. at the intersection between the given micro-optical element and the wavefront arriving on the given micro-optical element. The micro-optical elements having a diffusive optical function may be similar to the micro-optical elements described in the document U.S. Pat. No. 10,302,962.

In the example illustrated by FIG. 11, the micro-optical elements of the first 10 or second 20 lens are located on the front face F1 of the first or second optical lens 10, 20.

Alternatively, at least a part or all the micro-optical elements of the first 10 or second lens 20 are located on the rear face F2 of the first or second lens 10, 20 or on both front face 11 and rear face 12 of the first or second lens 10, 20.

Alternatively, all or a part of the micro-optical elements of the first 10 or second 20 lens are embedded in the thickness of the first 10 or second 20 lens between its front and rear faces.

Still alternatively, at least a part or all the micro-optical elements of the first 10 or second 20 lens are formed on a film, in a form of a patch deposited on at least one of the front face and the rear face of the first or second lens 10, 20.

In a variant, at least part or all the micro-optical elements are formed by lamination on at least one of the front face and the rear face of the first or second lens 10, 20.

In practice, the micro-optical elements are formed as a single integral part with the rest of the first 10 or second 20 lens (typically by injection molding, press-molding, rolling or machining) or, as an alternative, on a film (forming of a patch or laminated) applied over one or both of the front face 11 and the rear face 12 of the first 10 or second 20 lens.

In the following, the wording “zone” of a lens is relative to an area of the first or second optical lens defined in a same projection plane (i.e. the plane of FIGS. 1-10). Consequently, when a zone of the first optical lens 10 is compared with a zone of the second optical lens 20, said two zones are defined in the same projection plane. By projection plane, it is meant a flat plane of the first or second lens 10, 20 without considering the curvature of this considered lens.

In a non-limitative example, the arrangement 11 of the micro-optical elements of the first lens 10 has features to provide a first evolution control function of the myopia for the first eye of the wearer. Typically, the first evolution control function of the myopia is achieved by the micro-optical function of the micro-optical component of the first lens 10. The arrangement 21 of the micro-optical elements of the second lens 20 has features to provide a second evolution control function of the myopia for the second eye of the wearer. Typically, the second evolution control function of the myopia is achieved by the micro-optical function of the micro-optical component of the second lens 20. In other words, the micro-optical elements of the first lens 10 and the micro-optical elements of the second lens 20 have each features adapted to control the myopia progression.

To this end, the arrangement of the micro-optical elements of the first lens 10 are adapted to provide a specific spatial distribution of blur and the micro-optical elements of the second lens 20 have features adapted to provide another different spatial distribution of blur also called defocus effect. Thus, the arrangement 11 of micro-optical elements of the first lens 10 has features to provide a first defocus spatial function and the arrangement 21 of micro-optical elements of the second lens 20 has features to provide a first defocus spatial function. In an exemplary embodiment, the micro-optical elements comprise micro-lenses providing a refractive power.

In a variant, the micro-optical elements provide diffractive or diffusive optical function. When the micro-optical elements provide a diffusive optical function, the light that enters in the eye of the wearer is scattered (e.g. non focused). Thanks to the first and second evolution control functions, the light beam (composed of light rays) that passes thought the first lens 10 and respectively through the second lens 20 is separated into two parts:
a first part that corresponds to light rays which are deviated by the macro-optical component of the given lens (the first 10 or second 20 lens) and which are not affected by the arrangement of micro-optical elements. Typically, the first part corresponds to light rays that do not pass through one of the micro-optical elements of the arrangement of micro-optical elements;
a second part that corresponds to light rays which are affected by the micro-optical component (i.e. the arrangement of micro-optical elements) of the given lens and by the macro-optical component.

Typically, the second part of the light beam is referred to as myopia control signal. The myopia control signal can be quantified by a light intensity referred to, in the following, as intensity of the myopia control signal.

The myopia control signal depends on the features of the micro-optical elements, here based on the given evolution control function of the myopia (first or second evolution control function of the myopia). Typically, the myopia control signal depends on the refractive, diffractive or diffusive optical function of the micro-optical elements. To this end, the myopia control signal is:
a diffusive signal if the micro-optical elements have a diffusive function. As explained above, the diffusive signal corresponds to a non-focused signal, typically a scattered signal;
a diffractive signal if the micro-optical elements have a diffusive function. As explained above, the diffractive signal corresponds to a non-focused signal, typically a scattered signal;
a refracted signal if the micro-optical elements have a diffusive function (defocus effect via the given defocus spatial function). The refracted signal corresponds to a focused signal. Typically, in that case, the light rays that enter into the eye of the wearer are focused in front of the surface of the retina, on a defocus plane positioned in front of the surface of the retina. In contrast, regarding the first part of the light rays, the macro-optical function of the given lens providing the prescribed refractive power for dioptric correction of the given eye focuses light rays that enter into the eye on the surface of the retina of the eye.

In the example of FIG. 1, the first lens 10 comprises a central zone 12 bounded by a circular outline 31. In this example, the central zone 12 of the first lens 10 is without any micro-optical element and has a circular shape, for example of 4 millimeters in radius (defined in this example between the ophthalmic lens center V10 of the first lens 10 and the circular outline 31 of the central zone 12).

The second optical lens 20 comprises a central zone 22 bounded by a circular outline 41. In this example, the central zone 22 of the second lens 20 is without any micro-optical element and has a circular shape, for example of 4 millimeters in radius (defined in this example between the ophthalmic lens center V10 of the first lens 10 and the circular outline 41 of the central zone 22).

The central zone 12, 22 without any optical element is configured to maximize the acuity of the wearer in this zone as this zone does not comprise micro-optical element.

Of course, in other embodiments, the central zone 12 of the first lens 10 and/or the central zone of the second lens 20 may have different shapes, for example hexagonal shape, or elliptical shape, or octagonal shape, or triangular shape, or polygonal shape, or asymmetrical shape, and different sizes, for example a transverse size or a diameter comprised between 2 and 6 millimeters.

The first lens 10 further comprises a first peripheral zone 13 arranged around the central zone 12 of the first lens 10. The first peripheral zone 13 is bounded internally by an inner outline which coincides with the outer outline 31 of the central zone 12 and externally by an outer outline 32. In the example of the FIG. 1, the arrangement 11 of the micro-optical elements of the first lens 10 is disposed on the first peripheral zone 13 of the first lens 10.

The first lens 10 further comprises a second peripheral zone 18 arranged around the first peripheral zone 13. The second peripheral zone 18 is bounded internally by an inner outline which coincides with the outer outline 32 of the first peripheral zone 13 and externally by an outer outline 33 which coincides with the outer edge 33 of the first lens 10.

The central zone 12, the first peripheral zone 13 and the second peripheral zone 18 are concentric.

The second lens 20 further comprises a first peripheral zone 23 arranged around the central zone 22 of the second lens 20. The first peripheral zone 23 is bounded internally by an inner outline which coincides with the outer outline 41 of the central zone 22 and externally by an outer outline 42. In the example of the FIG. 1, the arrangement 21 of the micro-optical elements of the second lens 20 is disposed on the first peripheral zone 23 of the second lens 20.

The second lens 20 further comprises a second peripheral zone 28 arranged around the first peripheral zone 23. The second peripheral zone 28 is bounded internally by an inner outline which coincides with the outer outline 42 of the first peripheral zone 23 and externally by an outer outline 43 which coincides with the outer edge 43 of the second lens 20.

The central zone 22, the first peripheral zone 23 and the second peripheral zone 28 are concentric.

By first peripheral zone it is meant a specific area of the first lens 10 or the second lens 20.

By second peripheral zone it is meant a specific area of the first lens 10 or the second lens 20 arranged to be fixed to a frame 70 of a spectacle lenses. The second peripheral zone is without any optical element.

In the example of FIG. 1, the first peripheral zone 13 of the first lens 10 has the same size as the first peripheral zone 23 of the second lens 20.

In this embodiment, the first peripheral zone 13 of the first lens 10 is symmetric with the first peripheral zone 23 of the second lens 20 relative to the sagittal plane 30 of the pair of spectacle lenses 100.

The sagittal plane 30 is perpendicular to the projection plane (plane of FIGS. 1, 7, 8 and 10). When the first lens 10 and the second lens 20 are mounted on a frame 70 worn by a wearer in standard wearing conditions, the sagittal plane 30 is disposed in the sagittal plane of the wearer. The sagittal plane of the wearer is a physiological plane. The sagittal plane of the wearer corresponds to a vertical median plane of the head of the wearer. The sagittal plane of the wearer is the plane orthogonal a Frankfurt plane passing through the middle of the two centers of rotation of the first and second eye (right eye and left eye). Here the sagittal plane of the wearer is perpendicular to the segment that passes through the centers of rotation of the two eyes of the wearer and that passes in the middle of this segment. The sagittal plane of the wearer is vertical when the wearer holds his head in a straight posture.

The arrangement 11 of the micro-optical elements of the first lens 10, arranged in this example in the first peripheral zone 13 of the first lens 10, differs from the arrangement 21 of the micro-optical elements of the second lens 20, arranged in this example in the first peripheral zone 23 of the second lens 20.

More precisely, the arrangement 11 of the micro-optical elements of the first lens 10 and the arrangement 21 of the micro-optical elements of the second lens 20 are asymmetrical relatively to the sagittal plane 30 of the pair of spectacle lenses 100.

By asymmetric, it is meant that the arrangement of the micro-optical elements of the first lens differs from the arrangement 21 of the micro-optical elements of the second lens 20. It means that the features of the arrangement 11 of the micro-optical elements of the first lens 10 differs from the features of the arrangement 21 of the micro-optical elements of the second lens 20.

According to the present disclosure, the arrangement 11 of micro-optical elements of the first lens 10 differ from the arrangement 21 of micro-optical elements of the second lens 20 by at least one of the following parameters:
shape of the micro-optical elements;
density of the micro-optical elements or number or quantity of micro-optical elements in each arrangement of optical element;
dioptric power of the micro-optical elements;
geometry of the micro-optical elements;
refractive, diffractive or diffusive optical function of the micro-optical elements;
type of micro-optical elements: refractive, diffractive or diffusing microlenses, Pi-Fresnel microlenses, diffraction grating, bifocal, multifocal microlenses, scattering dots, Fresnel or toric structures;
focal length of the micro-optical elements;
size or diameter of the micro-optical elements;
position of the arrangement of the micro-optical elements in a visual field of the first lens and of the second lens;
position of the micro-optical elements in the arrangement of the micro-optical elements;
position of the micro-optical elements in each arrangement of micro-optical elements;
geometrical or random structure of each arrangement of micro-optical elements.

For example, the micro-optical elements of the first lens 10 and the second lens 20 comprise micro-optical elements, such as microlenses having a disk shape. According to this embodiment, the value of the diameter of the micro-optical elements of the first lens 10 is of 1 millimeter, whereas the value of the diameter of the micro-optical elements of the second lens 20 is of 2 millimeters. The value of the optical power of the micro-optical elements of first lens 10 is of +2 diopters, whereas the value of the optical power of the micro-optical elements of second lens 20 is of +4 diopters. In addition, the number of micro-optical elements of the first lens 10 is configured to cover 60 percent of the surface of the first peripheral zone 13 of the first lens 10, whereas the number of micro-optical elements of the second lens 20 is configured to cover 40 percent of the surface of the first peripheral zone 23 of the second lens 20.

Preferably, the arrangement of micro-optical elements of the first lens and the arrangement of micro-optical elements of the second lens depend on the dominant eye of the wearer. The spectacle lenses according to the present disclosure is designed such that the dominant eye receives less myopia control signal via the evolution control function (as explained above) than the non-dominant eye to provide a maximum of visual acuity to both eyes of the wearer. For example, if the dominant eye is the first eye, at least one parameter of the arrangement of micro-optical elements of the first lens 10 is adapted to provide a defocus effect in the first peripheral zone 13 lower than the defocus effect in the first peripheral zone 23 provided by the arrangement of the micro-optical elements of the second lens 20.

The dominant eye may be assessed with known process for those skilled in the art. For example, the dominant eye may be assessed with binocular rivalry paradigm as disclosed in the document Qiu et al. 2020, “Binocular rivalry from luminance and contrast”, Vision Research, https://doi.org/10.1016/j.visres.2020.06.006.

FIGS. 2 to 4 show several examples of various arrangements of the micro-optical elements of the first lens 10 and/or the second lens 20. It must be understood that the optical design of the lens shown on FIG. 2 is combined with the optical design of a lens illustrated by FIG. 3 or 4 to form the pair of spectacle lens 100. Same apply to the embodiments shown on FIGS. 3 and 4.

On FIG. 2, each optical element 1 of the arrangement of micro-optical elements is contiguous with other micro-optical elements of this arrangement. In other words, the micro-optical elements of the arrangement shown on FIG. 2 are in contact with each other at the level of the edges of the micro-optical elements.

Such a contiguous arrangement of the micro-optical elements provides a higher density of micro-optical elements 1 over the first peripheral zone 13 of the first lens 10 or over the second peripheral zone 23 of the second lens 20. By high density, it is understood a coverage density defined as the ratio between the overall surface of the micro-optical elements with respect to the surface area of the lens or of the zone comprising said arrangement of the micro-optical elements. For example, the density of contiguous micro-optical elements 1 is greater than or equal to 60 percent, or 80 percent in surface. In this example, the density of the micro-optical elements over the first peripheral zone 13, 23 is of 100 percent. It means that the micro-optical elements cover the whole area of the first peripheral zone 13, 23.

In another embodiment, all the micro-optical elements shown on FIG. 2 are identical. It means that all the micro-optical elements of the arrangement of micro-optical elements shown on FIG. 2 present the same parameters. For example, the micro-optical elements illustrated on FIG. 2 are spherical microlenses and have each for example a diameter between 1 and 2 millimeters and a dioptric power of +2 diopter. The micro-optical elements 1 shown on FIGS. 2 and 15 are preferably diffractive or refractive micro-optical elements. In the example of FIGS. 2 and 15, the structure of the arrangement of the micro-optical elements has a hexagonal pattern. Alternatively, the structure of the arrangement may have a square or rectangular pattern as shown on FIG. 16.

As illustrated on FIG. 2, the arrangement of micro-optical elements comprises unifocal, or multifocal microlenses. When the micro-optical elements are unifocal, they can have different surface shapes: spherical, or aspherical, or toric.

FIG. 3 illustrates another example of arrangement of micro-optical elements. The micro-optical elements shown on FIG. 3 have a similar shape to the micro-optical elements illustrated on FIG. 2. In addition, the micro-optical elements shown on FIG. 3 have a similar dioptric power to the micro-optical elements shown on FIG. 2.

In the example of the FIG. 3, the micro-optical elements are not contiguous. Each optical element of the arrangement of micro-optical elements is of 1 millimeter in diameter and is spaced from the adjacent micro-optical elements by at least 0.1 millimeter. For example, the edge of one of optical element 1 of the arrangement of micro-optical elements is spaced from the edge of an adjacent optical element by 0.5 millimeter.

For instance, the density of the arrangement of the micro-optical elements over the first peripheral zone 13, 23 is lower than 80 percent, for example it is of 60 percent.

With such an arrangement of the micro-optical elements, the spacing between adjacent micro-optical elements is adapted to provide a specific defocus effect. Indeed, with such arrangement, the micro-optical elements illustrated on FIG. 3 have a density lower that the density of the micro-optical elements illustrated on FIG. 2. It means that the defocus effect in the first peripheral zone provided by the arrangement of micro-optical elements of the FIG. 3 is lower than the defocus effect in the first peripheral zone by the arrangement of micro-optical elements of the FIG. 2. Consequently, the visual acuity provided by the first lens 10 or the second lens 20 having the optical design illustrated on FIG. 3 is different from the visual acuity provided by the optical design provided of the example of the FIG. 2.

In a first embodiment, the first lens 10, preferably the first peripheral zone 13 of the first lens 10, comprises the arrangement of the micro-optical elements illustrated on FIG. 2, whereas the second lens 20, preferably the first peripheral zone 23 of the second lens 20, comprises the arrangement of the micro-optical elements illustrated on FIG. 3. Such a design of the pair of spectacle lenses 100 allows obtaining two different types of visual acuity and defocus effect for each eye.

FIG. 4 shows another embodiment of the arrangement of the micro-optical elements of the first lens 10 or the second lens 20.

In this example, the arrangement of the micro-optical elements comprises a plurality of rings of the micro-optical elements, the rings having increasing diameters around the central zone. The rings of optical element are in this example concentric. Each ring of the micro-optical elements for example is spaced from the adjacent ring by at least 0.5 millimeter, for example by 2 millimeters edge to edge.

The rings of the micro-optical elements are comprised in the first peripheral zone 13 of the first lens 10 or in the first peripheral zone 23 of the second lens 20.

The density of the micro-optical elements of the arrangement of the micro-optical elements shown on FIG. 4 is greater than 30 percent over the first peripheral zone 13, 23 of first 10 or second 20 lens, preferably of 40 percent.

In a non-limitative embodiment, the first lens 10 of FIG. 1 comprises the arrangement of the micro-optical elements shown on FIG. 4 and the second lens 20 of FIG. 1 comprises the arrangement of the micro-optical elements of FIG. 2 or FIG. 3. Such a design of the pair of spectacle lenses 100 allows obtaining two different types of visual acuity and defocus effect for the two eyes.

FIG. 5 shows a Modulation Transfer Function (MTF) of the first lens and FIG. 6 shows a modulation transfer function of the second lens 20 of the pair of spectacle lenses 100 illustrated by FIG. 1. This modulation transfer function enables to evaluate the defocus effect induced by a lens with the arrangement of the microlenses, depending on the spatial zone of the lens.

The modulation transfer functions of these examples are computed on a specific zone Zo of the first 10 (for FIG. 5) or second 20 lens (for FIG. 6). To this end, the zone Zo has a circular shape having a diameter comprised between 3 and 10 millimeters. According to the present disclosure, the specific zone Zo of the first lens 10 or the second lens 20 can be defined over the whole area of the first lens 10 or the second lens 20. The specific zone Zo of the first 10 or second lens 20 comprises micro-optical elements. Typically, the density of the micro-optical elements in the zone Zo is superior to 40 percent. In the following disclosure, the modulation transfer function can be directly measured using an optical system S as described on FIG. 14.

The system S comprises a light capturing device C, a light emitting device I configured to generate a collimated beam CB of light, and an aperture P positioned on the first 10 or second lens 20 or very close to the first 10 and second 20 lens and used as a diaphragm to delimit the specific zone Zo of the first 10 or second lens 20 on which the modulation transfer function is measured. Only the rays of the collimated beam passing through the aperture P reach the light capturing device. Here, the aperture P is positioned on or in front of the front face F1 of the first 10 or second 20 lens. Of course, in a variant of the system S, the aperture P may be positioned on the rear face F2 of the first 10 or second lens 20 or behind the rear face F2 of the first lens 10 or second lens 20.

On FIG. 14, the first 10 or the second lens 20 is positioned between the light emitting device I and the light capturing device C. The light emitting device I, the aperture P, the first 10 or second lens 20 and the light capturing device C are aligned.

The light source I is a laser source emitting in the monochromatic or polychromatic visible spectrum between 400 nm and 780 nm (λ), with a high-quality factor M² close to 1. Advantageously, the collimated beam emitted by the light source I has a wavelength between 540 to 560 nm, preferably a wavelength of 550 nm.

The collimated beam CB is generated by the light emitting device I along an axis A sensibly perpendicular to a plane normal to the surface of the first 10 or second 20 lens and centered on a center of the specific zone Zo of first 10 or second lens 20. As shown on FIG. 14, the collimated beam illuminates the whole area of the specific portion Zo of the first 10 or second lens 20.

On FIG. 14, the first 10 or second 20 lens can be moved along a plane perpendicular to the axis A to select different specific zones Zo of the first 10 and second 20 lens so as to measure the modulation transfer function on different portions of the first 10 and second 20 lens.

As the first 10 or second lens 20 is illuminated by a collimated beam the distance between the light emitting device I and the first 10 or second lens 20 can vary without changing substantially the determined modulation transfer function.

The light capture device C comprises at least a lens L and an image sensor Sb. The position of the lens L and the position of the sensor Sb can be adjusted in order to consider different analysis planes, for example to scan the first 10 or second lens 20 along the axis z₁ or z₂.

The sensor Sb is configured to capture the image obtained by the collimated light beam generated by the light source I, and that is passed through the first 10 or second lens 20. Based on this captured image, one can determine the Point Spread Function (PSF) and then the Modulation Transfer Function of the zone Zo of the first 10 or second 20 lens by computing the Fourier Transform of the Point Spread Function.

In another embodiment, the modulation transfer function of the zone Zo of the first 10 or second lens 20 is determined by measuring a surface relief of the face of the first 10 or second 20 lens comprising the micro-optical elements, here the front face F1 of the considered lens. Typically, the surface relief of the face can be determined using an interferometer. The difference of the optical path lengths of two points belonging to the zone Zo is determined. To this end, one can multiply a difference of the surface relief of the two different points of the zone Zo by a value equal to a refractive index of the given lens (i.e. index of the macro-optical function). In a variant, one can compute the Point Spread Function and then the Modulation Transfer Function in different planes of the given lens.

In a variant, simulated modulation transfer functions are computed. In that case, the specific zone Zo of the given lens is selected by a simulated aperture P′ (i.e. a diaphragm) positioned on the optical design of the first lens 10 or second lens 20 or by projecting the pupil P′ of the eye on the first 10 or second lens 20. In both cases, the diaphragm P′ or the projection is centered on the central vision gaze direction defined with the two angles (αC, βC) shown on FIG. 12.

As for the method explained above, it is possible to compute the modulation transfer function on different specific zones Zo of the simulated first lens 10 or second lens 20 by spatially scanning the field of view of the first lens 10 or second lens 20 using simulated aperture P′ or projection P′ defined for several central vision gaze directions. It allows measuring the modulation transfer function for different eccentricities of the vision gaze direction.

The Point Spread Function (PSF) giving the degree of spreading (blurring) in the image of a point object throughout the considered portion Zo of the first lens 10 or second lens is computed. The Point Spread Function is computed by simulations known to the skilled person, using a point source emitting in the monochromatic or polychromatic visible spectrum between 400 nm and 780 nm (λ), typically in a form of an ideal gaussian (M²=1), centered on ophthalmic lens center V10, V20 of the first or second lens 10, 20. For each wavelength λ, the point spread function is calculated as the squared magnitude of the inverse Fourier transform of an aperture function P′(x_{1;2}, y_{1;2}) defined as P′(x_{1;2}, y_{1;2})=A(x_{1,2}, y_{1;2})exp(ikW(x_{1;2}, y_{1;2})) simulating the simulated aperture P′ and where k is the wave number (2π/λ), λ the wavelength of the point source preferably equal to 550 nm, A(x_{1;2}, y_{1;2}) an apodization function that may be equal to 1, and W(x_{1;2}, y_{1;2}) corresponding to the optical path difference provided by first 10 or second 20 lens. Then, the modulation transfer function is computed based on the Fourier transform of the computed point spread function.

In the examples of FIGS. 5 and 6, the modulation transfer functions are computed or measured at a wavelength of 550 nm and with a zone Zo having 4 millimeters in diameter and for a gaze direction (α_{c}, β_{c}) presenting an eccentricity of 6.6 millimeters relative to the ophthalmic lens center V10 of the first lens 10 for the example illustrated by FIG. 5 or relative to the ophthalmic lens center V20 of the second lens 20 for the example illustrated by FIG. 6. In the present disclosure, the wording eccentricity refers to a distance between the ophthalmic lens center V10, V20 of the considered lens and a point on the given lens that corresponds to the center of the zone Zo. In another embodiment, the modulation transfer function can be estimated for different eccentricities, for example eccentricities comprised between 4 millimeters and 26 millimeters when the central zone 12, 22 of the first or second lens is without any micro-optical element. If the central zone 12, 22 of the first or second lens comprises micro-optical element, the modulation transfer function can be further estimated for lower eccentricities, for example comprised between 0 (central gaze direction) and 4 millimeters.

FIG. 5 shows a horizontal axis profile of the modulation transfer function of the first lens 10 and a vertical axis profile of the modulation transfer function of the first lens 10.

In this example, the first lens 10 has contiguous micro-optical elements as shown on FIG. 2. In this embodiment, the micro-optical elements may be for example Pi-Fresnel micro-optical elements having a diameter of 2 millimeters and having dioptric powers between 0 and 10 diopters. Preferably, in this example, the Pi Fresnel micro-optical elements of the first lens 10 have a dioptric power P₀(λ₀) equal to 0 diopter and a dioptric power P₁(λ₀) equal to 4 diopters.

In the present disclosure, the horizontal axis profile of the modulation transfer function corresponds to the variation of the modulation transfer function estimated or computed along the horizontal axis x₁ of the first lens 10 or respectively along the horizontal axis x₂ of the second lens 20. In the following, this profile is called horizontal modulation transfer function. The horizontal modulation transfer function corresponds to a cut view of the Fourier Transform of the Point Spread Function along the horizontal axis x₁ of the first 10 or respectively along the horizontal axis x₂ of second 20 lens. In contrast, the vertical axis profile of the modulation transfer function corresponds to the variation of the modulation transfer function computed or estimated along the vertical axis y₁ of the first lens 10 or respectively along the vertical axis y₂ of the second lens 20. In the following, this profile is called vertical modulation transfer function. The vertical modulation transfer function corresponds to a cut view of the Fourier Transform of the Point Spread Function along the vertical axis y₁ of the first 10 lens or respectively along the vertical axis y₂ second 20 lens.

On FIG. 5, the vertical modulation transfer function and the horizontal transfer function follow the same variation, they are superimposed on each other. It means that the optical design of the first lens 10 provides a same optical function along the vertical axis y₁ and along the horizontal axis x₁. Consequently, for the example shown on FIG. 5, the present disclosure only uses the wording modulation transfer function when speaking about the vertical and horizontal modulation transfer functions.

According to this embodiment, the modulation transfer function presents values higher than or equal to 0.60, 0.65, 0.70, 0.75, 0.80, 0.85, 0.90, 0.95 (a.u.) over the range of spatial frequencies comprised between 0 and 7 cycles per degree, preferably between 0 and 5 cycles per degree.

On FIG. 5, the modulation transfer function of the first lens 10 at the spatial frequency of 5 cycles per degree is lower than or equal to 0.4, preferably lower than 0.35. According to this example, the modulation transfer function reaches a minimum of 51 (a.u.) over the spatial frequencies comprised between 3 and 5 cycles per degree.

The modulation transfer function presents values lower than or equal to 0.50, 0.45, 0.40, 0.35 (a.u.) over the range of spatial frequencies comprised between 2 and 7 cycles per degree.

In addition, the modulation transfer function of the first lens 10 presents an attenuation at spatial frequencies between 4 and 5 cycles per degree. Then, the modulation transfer function of the first lens 10 presents values which are greater than 0.4 preferably greater than 0.35 for spatial frequencies between 6 and 12 cycles per degree. Thus, the modulation transfer function over the range of spatial frequencies comprised between 6 and 11 cycles per degree presents a spike 52. For this range of spatial frequencies, the modulation transfer function reaches a maximum 53 for spatial frequency equal to 9 cycles per degree. Then, the modulation transfer function on FIG. 5 decreases after the maximum 53 for the spatial frequencies higher than 9 cycles per degree.

The modulation transfer function presents values higher than or equal to 0.30, 0.35, 0.40, 0.41 over the range of spatial frequencies comprised between 6 and 12 cycles per degree.

The first lens 10 provides good visual performance for middle spatial frequencies, specifically for spatial frequencies between 5 and 10 cycles per degree.

FIG. 6 shows a horizontal axis profile 63 of the modulation transfer function of the second lens 20 and a vertical axis profile 64 of the modulation transfer function of the second lens 20.

The second lens 20 of the embodiment of the pair of spectacle lenses 100 comprises an arrangement of the micro-optical elements for example as shown on FIG. 10 presenting features (parameters) that vary depending on each of the four quadrants at 45 degrees. In this embodiment, the micro-optical elements are unifocal contiguous micro-optical elements having a diameter of 0.6 millimeter and a dioptric power between 3.5 and 6 diopters.

In this example, the horizontal axis profile 63 of the modulation transfer function of the second lens 20 and a vertical axis profile 64 of the modulation transfer function of the second lens 20 are estimated or computed with an aperture P′, P of 4 millimeter in diameters and for a gaze direction (α_{c}, β_{c}) presenting an eccentricity of 6.6 millimeters (with respect to the ophthalmic lens center V20 of the second lens 20).

In the example of FIG. 6, the vertical modulation transfer function and the horizontal transfer function do not follow the same variation. It means that the optical design of the second lens 20 provides a different optical function along the vertical axis y₂ and along the horizontal axis x₂.

On FIG. 6, the horizontal modulation transfer function 63 presents a plurality of spikes and a plurality of valleys. Specifically, the horizontal modulation transfer function 63 of FIG. 6 reaches:
a maximum 65a having a value higher than 0.9 at spatial frequency of 0 cycle per degree;
a maximum 65b having a value comprised between 0.85 and 0.75 for spatial frequencies comprised between 18 and 21 cycles per degree;
a maximum 65c having a value comprised between 0.65 and 0.55 for spatial frequencies comprised between 35 and 42 cycles per degree;
a maximum 65d having a value comprised between 0.50 and 0.40 for spatial frequencies comprised between 54 and 57 cycles per degree.

The horizontal modulation transfer function 63 presents values higher than or equal to 0.33 over the range of spatial frequencies comprised between 18 and 21 cycles per degree and values higher than or equal to 0.3 over the range of spatial frequencies comprised between 35 and 42 cycles per degree, and values higher than or equal to 0.2 over the range of spatial frequencies comprised between 54 and 57 cycles per degree. Preferably, the maximum 65 of the horizontal transfer function 63 is higher than or equal to 0.6 over the range of spatial frequencies comprised between 18 and 21 cycles per degree, and the maximum 65 of the horizontal transfer function 63 is higher than or equal to 0.5 over the range of spatial frequencies comprised between 35 and 42 cycles per degree, and the maximum 65 of the horizontal transfer function 63 is higher than or equal to 0.35 over the range of spatial frequencies comprised between 54 and 57 cycles per degree.

The horizontal modulation transfer function 63 presents values higher than or equal to 0.60, 0.65, 0.70, 0.75, 0.80, 0.85, 0.90, 0.95 over the range of spatial frequencies comprised between 0 and 7 cycles per degree, preferably between 0 and 5 cycles per degree.

The horizontal modulation transfer function presents values higher than or equal to 0.60, 0.65, 0.70, 0.75, 0.80, over the range of spatial frequencies comprised between 15 and 23 cycles per degree. In addition, according to this embodiment, the horizontal modulation transfer function 63 presents values higher than or equal to 0.40, 0.45, 0.50, 0.55, 0.60, over the range of spatial frequencies comprised between 33 and 43 cycles per degree. Then, the horizontal modulation transfer function 63 presents values higher than or equal to 0.30, 0.35, 0.40, 0.42, over the range of spatial frequencies comprised between 53 and 57 cycles per degree.

In addition, in the example of FIG. 6, the horizontal modulation transfer function 63 is attenuated around 10 cycles per degree, 28 cycles per degree and 47 cycles per degree. Preferably, the horizontal modulation transfer function 63 of FIG. 6 reaches:
a minimum 67a having a value comprised between 0.40 and 0.30 for spatial frequencies comprised between 8 and 12 cycles per degree;
a minimum 67b having a value comprised between 0.30 and 0.20 for spatial frequencies comprised between 25 and 32 cycles per degree;
a minimum 67c having a value comprised between 0.25 and 0.15 for spatial frequencies comprised between 41 and 52 cycles per degree.

The horizontal modulation transfer function 63 presents values lower than or equal to 0.5, preferably lower than or equal than 0.4, over the range of spatial frequencies comprised between 8 and 12 cycles per degree and values lower than or equal to 0,35 over the range of spatial frequencies comprised between 25 and 32 cycles per degree, and values lower than or equal to 0.3, preferably lower than or equal to 0.26, over the range of spatial frequencies comprised between 41 and 52 cycles per degree. Preferably, the minimum 67 of the horizontal transfer function 63 is lower than or equal to 0.35 over the range of spatial frequencies comprised between 8 and 12 cycles per degree, and the minimum 67 of the horizontal transfer function 63 is lower than or equal to 0.28 over the range of spatial frequencies comprised between 25 and 32 cycles per degree, and the minimum 67 of the horizontal transfer function 63 is lower than or equal to 0.24 over the range of spatial frequencies comprised between 41 and 52 cycles per degree.

According to this embodiment of the present disclosure, the horizontal modulation transfer function 63 presents values lower than or equal to 0.50, 0.45, 0.40, 0.35 over the range of spatial frequencies comprised between 6 and 12 cycles per degree, preferably between 8 and 12 cycles per degree. In addition, the horizontal modulation transfer function 63 presents values lower than or equal to 0.45, 0.40, 0.35, 0.30, 0.28 over the range of spatial frequencies comprised between 25 and 35 cycles per degree, preferably between 25 and 32 cycles per degree. Then, the horizontal modulation transfer function 63 presents values lower than or equal to 0.40, 0.35, 0.30, 0.25, 0.23, 0.20 over the range of spatial frequencies comprised between 41 and 54 cycles per degree, preferably between 45 and 52 cycles per degree.

On FIG. 6, the vertical modulation transfer function 64 presents a spike and a plurality of valleys. Specifically, the vertical modulation transfer function 64 of FIG. 6 reaches a maximum 66 between 30 and 33 cycles per degree.

According to this embodiment the vertical modulation transfer function 64 presents values higher than or equal to 0.60, 0.65, 0.70, 0.75, 0.80, 0.85, 0.90, 0.95 over the range of spatial frequencies comprised between 0 and 7 cycles per degree, preferably between 0 and 5 cycles per degree.

According to this embodiment the vertical modulation transfer function 64 presents values higher than or equal to 0.40, 0.45, 0.50, 0.55, 0.60, 0.63, 0.65 over the range of spatial frequencies comprised between 28 and 38 cycles per degree, preferably between 30 and 35 cycles per degree.

In addition, in the example of FIG. 6, the vertical modulation transfer function 64 is attenuated between 10 and 26 cycles per degree, between 40 and 60 cycles per degree. Preferably, the vertical modulation transfer function 64 of FIG. 6 reaches:
a minimum 68a having a value comprised between 0.35 and 0.25 for spatial frequencies comprised between 10 and 28 cycles per degree;
a minimum 68b having a value comprised between 0.25 and 0.15 for spatial frequencies comprised between 40 and 60 cycles per degree.

According to this example, the vertical modulation transfer function 64 presents values lower than or equal to 0.33 over the range of spatial frequencies comprised between 10 and 26 cycles per degree and values lower than or equal to 0.3 over the range of spatial frequencies comprised between 10 and 26 cycles per degree.

In this embodiment, the vertical modulation transfer function 64 presents values lower than or equal to 0.45, 0.40, 0.35, 0.34, 0.33, 0.32 over the range of spatial frequencies comprised between 6 and 28 cycles per degree, preferably between 10 and 16 cycles per degree. Then, the vertical modulation transfer function 64 presents values lower than or equal to 0.35, 0.30, 0.25, 0.20, 0.19, 0.18 over the range of spatial frequencies comprised between 37 and 60 cycles per degree, preferably between 40 and 60 cycles per degree.

The second lens 20 presents a vertical modulation transfer function and a vertical modulation transfer function with peaks and valleys. Such a design provides good visual performance for high spatial frequencies, specifically for frequencies between 20 and 30 cycles per degree.

With the pair of spectacle lenses 100 according to the present disclosure, the vertical modulation transfer function of the first lens 10 differs from the vertical modulation transfer function of the second lens 20. In addition, the horizontal modulation transfer function of the first lens 10 differs from the horizontal modulation transfer function of the second lens 20. Consequently, the first lens 10 presents good optical performances for a specific range of frequencies, and the second lens 20 presents good optical performances for other specific range of frequencies.

According to this embodiment, the profile of the modulation transfer function of the first and second lens 10, 20 may be adapted to the dominant eye of the wearer.

For example, if the second eye of the wearer is the dominant eye and the wearer needs a pair of spectacle lenses for reading small character, then the optical design of the second lens 20 (thanks to the features of the micro-optical elements) is selected to provide high modulation transfer function (i.e. higher than 0.4, preferably higher than 0.5) over the range of spatial frequencies comprised between 20 and 30 cycles per degree and a low modulation transfer function over the range of spatial frequencies comprised between 5 and 10 cycles per degree. In contrast, the optical design of the first lens 10 is selected to provide high modulation transfer function over the range of spatial frequencies comprised between 5 and 10 cycles per degree and a low modulation transfer function over the range of spatial frequencies comprised between 20 and 30 cycles per degree. Thus, the second lens 20 provides a different defocus effect than the first lens 10.

A second embodiment of a pair of spectacle lenses 200 according to the present disclosure is described in relation with FIGS. 2 to 4 and FIG. 7.

FIG. 7 shows the pair of spectacle lenses 200 having a first lens 10 and a second lens 20. The second lens 20 of the pair of spectacle lenses 200 is identical to the second lens 20 comprised in the pair of spectacle lenses 100. Consequently, only the differences between the pair of spectacle lenses 100 on FIG. 1 will be described.

In this embodiment, the central zone 12 of the first lens 10 comprises micro-optical elements 1. Consequently, the arrangement 11 of the micro-optical elements of the first lens 10 extends over the central zone 12 of the first lens 10. This embodiment allows obtaining a first lens 10, which is entirely covered by the arrangement of the micro-optical elements. The first lens 10 does not contain any area without micro-optical element. Thus, the arrangement of the micro-optical elements of the second zone 15 of the first lens 10 and the arrangement of the micro-optical elements of the second zone 25 of the second lens 20 are asymmetrical relatively to a sagittal plane 30 of the pair of the spectacle lenses.

Preferably, the micro-optical elements 1 arranged in the central zone 11 of the first lens 10 have an arrangement similar to the micro-optical elements 1 arranged on the first peripheral zone 13 of the first lens 10. It means that the micro-optical elements of the first lens 10 have a similar pattern on the central zone 12 and on the first peripheral zone 13. This optical design provides a first lens 10 easy to manufacture, limiting the cost of the pair of spectacle lenses 200. This optical design is for example interesting because the manufacturing process of the first lens 10 does not need to consider an axis of cylinder in case of correction of astigmatism, improving the time and the easily of the manufacturing process.

A third embodiment of a pair of spectacle lenses 300 according to the present disclosure is described in relation with FIGS. 8 to 9.

In this embodiment, the first lens 10 and the second lens 20 comprise a central zone 12, 22. The central zone 12 of the first lens 10 is without any micro-optical element and the central zone 22 of the second lens 20 is without any micro-optical element.

In this embodiment, the first lens 10 and the second lens 20 are each divided in at least three complementary zones, the central zone 12, 22 and a first zone 14, 24 and a second zone 15, 25. The first zone 14 and the second zone 15 of the first lens 10 constitute the first peripheral zone 13 of the first lens 10 and respectively the first zone 24 and the second zone 25 of the second lens 20 constitute the first peripheral zone 23 of the second lens 20.

The first zone 14 of the first lens 10 is disposed above the secondary axis 40 and the first zone 24 of the second lens 20 is disposed below the secondary axis 40, and respectively the second zone 15 of the first lens 10 is disposed below the secondary axis 40 and the second zone 25 of the second lens 20 is disposed above the secondary axis 40. Of course, in a variant, the first zone 14 of the first lens 10 can be disposed below the secondary axis 40 and the first zone 24 of the second lens 20 can be disposed above the secondary axis 40, and respectively the second zone 15 of the first lens 10 can be disposed above the secondary axis 40 and the second zone 25 of the second lens 20 can disposed below the secondary axis 40.

In a preferred embodiment, the first zone 14 of the first lens 10 is identical to the first zone 24 of the second lens 20, and respectively the second zone 15 of the first lens 10 is identical to the second zone 25 of the second lens 20. To this end, the first zone 14 of the first lens 10 is symmetric with the first zone 24 of the second lens 20 by rotation of 180 degrees about an axis 50 perpendicular to the plane of FIG. 8, i.e. perpendicular to the mean plane of the lenses, and the axis 50 being in the sagittal plane 30 of the pair of spectacle lenses 300. Similarly, the second zone 15 of the first lens 10 is symmetric with the second zone 25 of the second lens 20 by rotation of 180 degrees about the axis 50 perpendicular to the plane of FIG. 8, i.e. perpendicular to the mean plane of the lenses, and the axis 50 being in the sagittal plane 30 of the pair of spectacle lenses 300. The first zone 14 and the second zone 15 of the first lens 10 comprise each an arrangement of the micro-optical elements and respectively the first zone 24 and the second zone 25 of the second lens 20 comprise each an arrangement of the micro-optical elements.

It means that the first lens 10 and the second lens 20 have each an optical design comprising a macro-optical component as explained above and two micro-optical components, called respectively first micro-optical component and second micro-optical component.

The first micro-optical component of the first 10 lens is defined in the first zone 14 of the first lens 10 and the second micro-optical component of the first 10 lens is defined in the second zone 15 of the first lens 10. The first micro-optical component of the second 20 lens is defined in the first zone 24 of the second lens 20 and the second micro-optical component of the second 20 lens is defined in the second zone 25 of the second lens 20.

The features of the micro-optical elements of the first zone 14 of the first lens 10 differ from the features of the micro-optical elements of the second zone 15 of the first lens 10. For example, the number of the micro-optical elements in the first zone 14 of the first lens 10 is lower than the number of the micro-optical elements in the second zone 15 of the first lens 10. In another example the size of the micro-optical elements of the first zone 14 is lower than the size of the micro-optical elements in the second zone 15 of the first lens 10.

Respectively the features of the micro-optical elements of the first zone 24 of the second lens 20 differ from the features of the micro-optical elements of the second zone 25 of the second lens 20. For example, the number of the micro-optical elements in the first zone 24 of the second lens 20 is lower than the number of the micro-optical elements in the second zone 25 of the second lens 20. In another example the size of the micro-optical elements of the first zone 24 is lower than the size of the micro-optical elements in the second zone 25 of the second lens 20.

On FIG. 8, the first micro-optical component of the first 10 is similar to the first micro-optical component of the second lens 20. To this end, it means that:
the arrangement of the micro-optical elements comprised in the first zone 14 of the first lens 10 is similar to the arrangement of micro-optical elements comprised in the first zone 24 of the second lens 20, and
the features of the micro-optical elements in the first zone 14 of the first lens 10 are similar to the features of the micro-optical elements comprised in the first zone 24 of the second lens 20.

In other words, the arrangement of the micro-optical elements in first zone 14 of the first lens 10 is symmetric with the arrangement of the micro-optical elements in the first zone 24 of the second lens 20 by rotation of 180 degrees about the axis 50 passing through the sagittal plane 30 and perpendicular to a mean plane of the pair of spectacle lenses.

The second micro-optical component of the first 10 is similar to the second micro-optical component of the second lens 20. To this end, it means that:
the arrangement of the micro-optical elements comprised in the second zone 15 of the first lens 10 is identical to the arrangement of the micro-optical elements comprised in the second zone 25 of the second lens 20, and
the features of the micro-optical elements in the second zone 15 of the first lens 10 are the similar to the features of micro-optical elements comprised in the second zone 25 of the second lens 20.

In other words, the arrangement of the micro-optical elements in second zone 15 of the first lens 10 is symmetric with the arrangement of the micro-optical elements in the second zone 25 of the second lens 20 by rotation of 180 degrees about the axis 50 passing through the sagittal plane 30 and perpendicular to a mean plane of the pair of spectacle lenses.

This embodiment provides a pair of spectacle lenses 300 easy to manufacture because the first lens 10 is similar to the second lens 20, the second lens 20 being rotated of 180 degrees relatively to the axis 50.

However, the arrangement of micro-optical elements of the first zone 14 of the first lens 10 presents a difference in said feature compared to the arrangement of the micro-optical elements of the second zone 25 of the second lens 20. Similarly, the arrangement of micro-optical elements of the second zone 15 of the first lens 10 presents a difference in said feature compared to the arrangement of the micro-optical elements of the first zone 24 of the second lens 20.

Thus, the arrangement of the micro-optical elements of the first zone 14 of the first lens 10 (or the first micro-optical function of the first lens 10) and the arrangement of the micro-optical elements of the second zone 25 of the second lens 20 (or the second micro-optical function of the second lens 20) are asymmetrical relatively to the sagittal plane 30 of the pair of spectacle lenses 100.

Similarly, the arrangement of the micro-optical elements of the second zone 15 of the first lens 10 (or the second micro-optical function of the first lens 10) and the arrangement of the micro-optical elements of the second zone 25 of the second lens 20 (or the first micro-optical function of the second lens 20) are asymmetrical relatively to the sagittal plane 30 of the pair of spectacle lenses 100.

In this example, the features of the micro-optical elements of the first zone 14 of the first lens 10 and respectively the second zone 14 of second lens 20 and the features of the micro-optical elements of the second zone 15 of the first lens 10 and respectively the second zone 25 of second lens 20 are each adapted to control the myopia progression. Typically, the features of the first zone 14 of the first lens 10 provide a first evolution control function of the myopia for the first eye of the wearer and the features of the second zone 15 of the first lens 10 provide a second evolution control function of the myopia for the first eye of the wearer. The features of the first zone 24 of the second lens 20 provide a first evolution control function of the myopia for the second eye of the wearer and the features of the second zone 25 of the second lens 20 provide a second evolution control function of the myopia for the second eye of the wearer.

To this end, the intensity of the myopia control signal provided by the second evolution control function of the myopia of the micro-optical elements of the second zone 15 of the first lens 10 is for example greater than the intensity of the myopia control signal provided by the first evolution control function of the myopia of the micro-optical elements of the first zone 14 of the first lens 10. This is achieved for example by a difference in the density and/or the size and/or dioptric power of the micro-optical elements. Similarly, the intensity of the myopia control signal provided by the second evolution control function of the myopia of the micro-optical elements of the second zone 25 of the second lens 20 is greater than the intensity of the myopia control signal provided by the first evolution control function of the myopia of the micro-optical elements of the first zone 24 of the second lens 20. Consequently, a good visual acuity is provided for the eye positioned on the side of the first lens 10 (i.e. the first eye) in the upper half part of the first lens 10 to ensure good vision performance for this eye while providing a defocus effect or a diffusive optical function to the other eye (i.e. the second eye). In contrast, a good visual acuity is provided for the other eye positioned on the side of the second lens 20 in the half lower part of the second lens 20 to ensure good vision performance for this other eye while providing a defocus effect or a diffusive optical function to the first eye.

According to this example, the features (or parameters) of first zone 14 the first lens 10 and the second zone 25 of the second lens 20 may be selected to provide good vision performance when the wearer is looking at an object positioned at far distance from him (i.e. for example object positioned at more than 5 meters from the eye of the wearer). Thus, in this example, the first zone 14 and the second zone 25 of the first and second lens 10, 20 may be dedicated to far vision.

In contrast, the features of second zone 15 the first lens 10 and the first zone 24 of the second lens 20 may be selected to provide good vision performance when the wearer is looking an object positioned at near and/or intermediate distance from him, for example an object positioned at less than 5 meters from the eye of the wearer. Thus, the second zone 15 and first zone 24 of the first and second lens 10,20 may be dedicated to near and/or intermediary vision.

This embodiment allows considering the dominant eye that may change according to the distance vision. Thus, the embodiment is configured to provide better visual acuity to the dominant eye according to the distance vision.

FIG. 9 shows an example of a pair of spectacle lenses 400 of the third embodiment disclosed on FIG. 8. Thus, only differences with the pair of spectacle lenses 300 shown on FIG. 8 will be disclosed.

On FIG. 9, the arrangement of micro-optical elements of the first zone 14 of the first lens 10 lens and the arrangement of micro-optical elements of the first zone 24 of the second 20 lens are each made of three arcs of circle centered on an optical center 19, 29 of the central zone 12, 22. In this example, the optical center 19 of the central zone is aligned in the visual axis of the first eye of the wearer and the optical center 29 of the central zone of second lens 20 is aligned on the visual axis of the second eye of the wearer in standard wearing conditions, when looking at infinity straight ahead.

In contrast, the arrangement of micro-optical elements of the second zone 15 of the first lens 10 lens and the arrangement of micro-optical elements of the second zone 25 of the second 20 lens are each made of five arcs of circle centered on the optical center of the central zone 19, 29.

On FIG. 9, the number of micro-optical elements of the second zone 15 of the first lens 10 is greater than the number of micro-optical elements of the first zone 14 of the first lens 10 and respectively the number of micro-optical elements of the second zone 25 of the second lens 20 is greater than the number of micro-optical elements of the first zone 24 of the second lens 20.

In addition, the micro-optical elements comprised in the first zone 14 of the first lens 10 and the micro-optical elements comprised in the first zone 24 of the second lens 20 have a size (i.e. diameter) lower than the size of the micro-optical elements comprised in the second zone 15 of the first lens 10 and the micro-optical elements comprised in the second zone 25 of the second lens 20.

For example, the micro-optical elements comprised in the second zone 15 of the first lens 10 and the micro-optical elements comprised in the second zone 25 of the second lens 20 are of 1 millimeter diameter and the micro-optical elements comprised in the first zone 14 of the first lens 10 and the micro-optical elements comprised in the first zone 24 of the second lens 20 are of 2 millimeters diameter.

A fourth embodiment of a pair of spectacle lenses 500 according to the present disclosure is described in relation with FIG. 10.

In this embodiment, the first lens 10 and the second lens 20 comprise a central zone 12, 22. The central zone 12 of the first lens 10 is without any optical element and the central zone 22 of the second lens 20 is without any optical element.

In this embodiment, the first lens 10 and the second lens 20 are each divided in five complementary zones, the central zone 12, 22, and four quadrants zones at 45 degrees defining respectively a first zone 14, 24, a second zone 15, 25, a third 16, 26 and a fourth 17, 27. The first zone 14, the second zone 15, the third zone 16, and the fourth zone 17 of the first lens 10 constitute the first peripheral zone 13 of the first lens 10 and respectively the first zone 24, the second zone 25, the third zone 26, and the fourth zone 27 of the second lens 20 constitute the first peripheral zone 23 of the second lens 20. In addition, the four quadrants of the first lens 10 comprise each an arrangement of micro-optical elements and respectively the four quadrants of the second lens 20 comprise each an arrangement of micro-optical elements. The four quadrants of the first lens 10 are defined in the first peripheral zone 13 of the first lens 10 and the four quadrants of the second lens 20 are defined in the first peripheral zone 23 of the second lens 20. In this example, the first peripheral zone 13 of the first lens 10 is divided into the four quadrants with two orthogonal axes, called first axis 81 and second axis 82 of the first lens 10. The first axis 81 of the first lens 10 is tilted by 45 degrees relatively to the axis 40 by a rotation of 45 degrees about the ophthalmic lens center V10 of the first lens 10 (anti-clockwise) and the second axis 82 of the first 10 is tilted by 45 degrees relatively to the axis 40 by a rotation of 45 degrees about the ophthalmic lens center V10 of the first lens 10 (clockwise). Similarly, the first peripheral zone 23 of the second lens 20 is divided into the four quadrants with two orthogonal axes, called first axis 91 and second axis 92 of the second lens 20. The first axis 91 of the second lens 20 is tilted by 45 degrees relatively to the axis 40 by a rotation of 45 degrees about the ophthalmic lens center V20 of the second lens 20 (anti-clockwise) and the second axis 92 of the second lens 20 is tilted by 45 degrees relatively to the axis 40 by a rotation of 45 degrees about the ophthalmic lens center V20 of the second lens 20 (clockwise).

On FIG. 10, the first zone 14 of the first lens, and respectively the second zone 25 of the second lens, is disposed in the upper part of the first lens 10, respectively of the second lens 20. The second zone 15 of the first lens, and respectively the first zone 24 of the second lens, is disposed in the lower part of the first lens 10, respectively of the second lens 20. The third zone 16 of the first lens 10, and respectively the third zone 26 of the second lens 20, is disposed on the temporal side of the pair of spectacle lenses. The fourth zone 17 of the first lens 10, and respectively the fourth zone 27 of the second lens 20, is disposed on the nasal side of the pair of spectacle lenses.

The first zone 14 of the first lens is positioned above the ophthalmic lens center V10 of the first lens 10 and the second zone 15 of the first lens 10 is symmetric with the first zone 14 by a rotation of 180 degrees about the axis z₁ (transverse axis z₁) passing through the ophthalmic lens center V10 of the first lens 10, and transverse to the axis 40. The third zone 16 of the first lens 10 is positioned on the right of the ophthalmic center V10 of the first lens 10 and the fourth zone 17 of the first lens 10 is symmetric with the third zone 16 by a rotation of 180 degrees about the axis z₁ passing thought the ophthalmic lens center V10 of the first lens 10 and the eye rotation center of the eye covered by the first lens 10.

On FIG. 10, the first zone 24 of the second lens 20 is positioned below the ophthalmic lens center V20 of the second lens 20 and the second zone 25 of the second lens 20 is symmetric with the first zone 24 by a rotation of 180 degrees about the axis z₂ (transverse axis) passing through the ophthalmic lens center V20 of the second lens 20, and transverse to the axis 40. The third zone 26 of the second lens 20 is positioned on the left of the ophthalmic center V20 of the second lens 20 and the fourth zone 27 of the second lens 20 is symmetric with the third zone 26 by a rotation of 180 degrees about the transverse axis z₂ passing thought the ophthalmic lens center V20 of the second lens 10 and the eye rotation center of the eye covered by the second lens 20.

The first zone 14 of the first lens 10 is identical to the first zone 24 of the second lens 20, the second zone 15 of the first lens 10 is identical to the second zone 25 of the second lens 20, the third zone 16 of the first lens 10 is identical to the third zone 26 of the second lens 20, and respectively the fourth zone 17 of the first lens 10 is identical to the fourth zone 27 of the second lens 20. To this end, the first zone 14 of the first lens 10 is symmetric with the first zone 24 of the second lens 20 by rotation of 180 degrees about the axis 50 perpendicular to the plane of FIG. 10, i.e. perpendicular to the mean plane of the lenses, and the axis 50 being in the sagittal plane 30 of the pair of spectacle lenses 500. Similarly, the second zone 15 of the first lens 10 is symmetric with the second zone 25 of the second lens 20 by rotation of 180 degrees about the axis 50 perpendicular to the plane of FIG. 10. The third zone 16 of the first lens 10 is symmetric with the third zone 26 of the second lens 20 by rotation of 180 degrees about the axis 50 perpendicular to the plane of FIG. 10 and the fourth zone 17 of the first lens 10 is symmetric with the fourth zone 27 of the second lens 20 by rotation of 180 degrees about the axis 50 perpendicular to the plane of FIG. 10.

The first 14, second 15, third 16 and fourth 17 zones of the first lens 10 comprise each an arrangement of the micro-optical elements and respectively the first 24, second 25, third 26 and fourth 27 zones of the second lens 20 comprise each an arrangement of the micro-optical elements.

It means that the first lens 10 and the second lens 20 have each an optical design comprising a macro-optical component as explained above and fourth micro-optical components, called respectively first micro-optical component, second micro-optical, third micro-optical component and fourth micro-optical component.

The first micro-optical component of the first 10 lens is defined in the first zone 14 of the first lens 10, the second micro-optical component of the first 10 lens is defined in the second zone 15 of the first lens 10, the third micro-optical component of the first 10 lens is defined in the third zone 16 of the first lens 10 and the fourth micro-optical component of the first 10 lens is defined in fourth zone 17 of the first lens 10. The first micro-optical component of the second 20 lens is defined in the first zone 24 of the second lens 20, the second micro-optical component of the second 20 lens is defined in the second zone 25 of the second lens 20, the third micro-optical component of the second 20 lens is defined in the third zone 26 of the second lens 20 and the fourth micro-optical component of the second 20 lens is defined in fourth zone 27 of the second lens 20.

On FIG. 10, the first micro-optical component of the first 10 is similar to the first micro-optical component of the second lens 20. To this end, it means that:
the arrangement of the micro-optical elements comprised in the first zone 14 of the first lens 10 is similar to the arrangement of micro-optical elements comprised in the first zone 24 of the second lens 20, and
the features of the micro-optical elements in the first zone 14 of the first lens 10 are similar to the features of the micro-optical elements comprised in the first zone 24 of the second lens 20.

In other words, the arrangement of the micro-optical elements in first zone 14 of the first lens 10 is symmetric with the arrangement of the micro-optical elements in the first zone 24 of the second lens 20 by rotation of 180 degrees about the axis 50 passing through the sagittal plane 30 and perpendicular to a mean plane of the pair of spectacle lenses.

The second micro-optical component of the first 10 is similar to the second micro-optical component of the second lens 20. To this end, it means that:
the arrangement of the micro-optical elements comprised in the second zone 15 of the first lens 10 is identical to the arrangement of the micro-optical elements comprised in the second zone 25 of the second lens 20, and
the features of the micro-optical elements in the second zone 15 of the first lens 10 are the similar to the features of micro-optical elements comprised in the second zone 25 of the second lens 20.

In other words, the arrangement of the micro-optical elements in second zone 15 of the first lens 10 is symmetric with the arrangement of the micro-optical elements in the second zone 25 of the second lens 20 by rotation of 180 degrees about the axis 50 passing through the sagittal plane 30 and perpendicular to a mean plane of the pair of spectacle lenses.

The third micro-optical component of the first 10 is similar to the third micro-optical component of the second lens 20. To this end, it means that:
the arrangement of the micro-optical elements comprised in the third zone 16 of the first lens 10 is similar to the arrangement of micro-optical elements comprised in the third zone 26 of the second lens 20, and
the features of the micro-optical elements in the third zone 16 of the first lens 10 are similar to the features of the micro-optical elements comprised in the third zone 26 of the second lens 20.

In other words, the arrangement of the micro-optical elements in third zone 16 of the first lens 10 is symmetric with the arrangement of the micro-optical elements in the third zone 26 of the second lens 20 by rotation of 180 degrees about the axis 50 passing through the sagittal plane 30 and perpendicular to a mean plane of the pair of spectacle lenses.

The fourth micro-optical component of the first 10 is similar to the fourth micro-optical component of the second lens 20. To this end, it means that:
the arrangement of the micro-optical elements comprised in the fourth zone 17 of the first lens 10 is identical to the arrangement of the micro-optical elements comprised in the fourth zone 27 of the second lens 20, and
the features of the micro-optical elements in the fourth zone 17 of the first lens 10 are the similar to the features of micro-optical elements comprised in the fourth zone 27 of the second lens 20.

In other words, the arrangement of the micro-optical elements in second fourth 17 of the first lens 10 is symmetric with the arrangement of the micro-optical elements in the fourth zone 27 of the second lens 20 by rotation of 180 degrees about the axis 50 passing through the sagittal plane 30 and perpendicular to a mean plane of the pair of spectacle lenses.

The features of micro-optical elements of the first zone 14 of the first lens 10 differ from the features of micro-optical elements of the second zone 15 of the first lens 10 and from the features of the optical element of the third zone 16 of the first lens 10 and from the features of the micro-optical elements of the fourth zone 17 of the second lens 20.

Respectively, the features of micro-optical elements of the first zone 24 of the second lens 20 differ from the features of micro-optical elements of the second zone 25 of the second lens 20 and from the features of the micro-optical elements of the third zone 26 of the second lens 20 and from the features of the micro-optical elements of the fourth zone 27 of the second lens 20.

In other words, it means that:
the arrangement of the micro-optical elements of the first zone 14 of the first lens 10 and the arrangement of the micro-optical elements of the second zone 25 of the second lens 20 are asymmetrical relatively to a sagittal plane 30 of the pair of the spectacle lenses;
the arrangement of the micro-optical elements of the second zone 15 of the first lens 10 and the arrangement of the micro-optical elements of the first zone 24 of the second lens 20 are asymmetrical relatively to a sagittal plane 30 of the pair of the spectacle lenses.

On FIG. 10, the features of the micro-optical elements of the first zones 14, 24 of the first 10 and second 20 lenses, the features of the micro-optical elements of the second zones 15, 25 of the first 10 and second 20 lenses, the features of the micro-optical elements of the third zones 16, 26 of the first 10 and second 20 lenses, and the features of the micro-optical elements of the fourth zones 17, 27 of the first 10 and second 20 lenses are each adapted to control the myopia progression.

Typically, the features of the first zone 14 of the first lens 10 provide a first evolution control function of the myopia for the first eye of the wearer, the features of the second zone 15 of the first lens 10 provide a second evolution control function of the myopia for the first eye of the wearer, the features of the third zone 16 of the first lens 10 provide a third evolution control function of the myopia for the first eye of the wearer, the features of the fourth zone 17 of the first lens 10 provide a fourth evolution control function of the myopia for the first eye of the wearer.

Similarly, the features of the first zone 24 of the second lens 20 provide a first evolution control function of the myopia for the second eye of the wearer, the features of the second zone 25 of the second lens 20 provide a second evolution control function of the myopia for the second eye of the wearer, the features of the third zone 26 of the second lens 20 provide a third evolution control function of the myopia for the second eye of the wearer, the features of the fourth zone 27 of the second lens 20 provide a fourth evolution control function of the myopia for the second eye of the wearer.

To this end, the intensity of the myopia control signal provided by the second evolution control function of the myopia of the micro-optical elements of the second zone 15 of the first lens 10 is greater than the intensity of the myopia control signal provided by the first evolution control function of the myopia of the micro-optical elements of the first zone 14 of the first lens 10. This is achieved for example by a difference in the density and/or the size of the micro-optical elements and/or dioptric power.

In this example, the micro-optical elements of the third zone 16 have features identical to the features of the micro-optical elements of the fourth zone 17 of the first lens 10. With such features, the arrangement of micro-optical elements of the third and fourth zones 16, 17 are similar, enabling an easier manufacturing process of the pair of spectacle lenses 500. In addition, the respective intensities of the myopia control signals provided by the third and fourth evolution control functions of the myopia of the micro-optical elements of the third 16 and fourth 17 zones of the first lens 10 are each greater than the intensity of the myopia control signal provided by the first evolution control function of the myopia of the micro-optical elements of the first zone 14 of the first lens 10. This is achieved for example by a difference in the density and/or the size of the micro-optical elements and/or dioptric power.

The respective intensities of the myopia control signals provided by the third and fourth evolution control functions of the myopia of the micro-optical elements of the third 16 and fourth 17 zones the first lens 10 are each lower than the intensity of the myopia control signal provided by the second evolution control functions of the myopia of the micro-optical elements of the second zone 15 of the first lens 10. This is achieved for example by a difference in the density and/or the size and/or dioptric power of the micro-optical elements.

Consequently, a good visual acuity is provided for the quadrant of the first lens 10 relative to the first zone 14 of the first lens 10, allowing to ensure good vision performance, for example when the wearer is looking an object positioned at far distance from him (i.e. for example object positioned at more than 5 meters from the eye of the wearer). Thus, the first part 14 of the first lens 10 may be dedicated for far vision. On the opposite, the second zone 15 of the first lens 10 may be dedicated for the myopia evolution control growth, as the third zone 16 and the fourth zone 17 of the first lens 10.

In this example, the micro-optical elements of the third zone 26 may have features identical to the features of the micro-optical elements of the fourth zone 27 of the second lens 20. With such feature, the arrangement of micro-optical elements of the third and fourth zones 26, 27 are similar. In addition, the respective intensities of the myopia control signals provided by the third and the fourth evolution control functions of the myopia of the micro-optical elements of the third 26 and fourth 27 zones of the second lens 20 are each greater than the intensity of the myopia control signal provided by the second evolution control function of the myopia of the micro-optical elements of the first zone 24 of the second lens 20. This is achieved for example by a difference in the density and/or the size of the micro-optical elements and/or dioptric power.

Then, the respective intensities of the myopia control signals provided by the third and fourth evolution control functions of the myopia of the micro-optical elements of the third 26 and fourth 27 zones of the second lens 20 are each lower than the intensity of the myopia control signal provided by the second evolution control function of the myopia of the micro-optical elements of the second zone 25 of the second lens 20. This is achieved for example by a difference in the density and/or the size of the micro-optical elements and/or dioptric power.

Consequently, a good visual acuity is provided for the quadrant of the second lens 20 relative to the first zone 24 of the second lens 20, allowing to ensure good vision performance, for example when the wearer is looking an object positioned at near and/or intermediate distance from him (i.e. for example object positioned at less than 5 meters from the eye of the wearer). Thus, the first part 24 of the second lens 20 may be dedicated for near and/or intermediate vision. On the opposite, the second zone 25 of the second lens 20 may dedicated for the myopia evolution control, as the third zone 26 and the fourth zone 27 of the second lens 20.

Typically, the first zones 14, 24 of the first 10 and second 20 lenses comprise each contiguous micro-optical elements (microlenses) having a diameter of 1 millimeter and dioptric powers between 0 and 10 diopters, preferably equal to 4 diopters.

The second zones 15, 25 of the first 10 and second 20 lenses comprise microlenses of 1 millimeter in diameter and a dioptric power between 1 and 10 diopters, preferably equal to 4 diopters. Each micro-optical element of the second zones 15, 25 of the first 10 and second 20 lenses is spaced from the adjacent micro-optical elements by at least 0.1 millimeter, typically by 1 millimeter edge to edge. The density of the arrangement of the micro-optical elements over the second zones 15, 25 of the first 10 and second 20 lenses is of 50 percent.

The third 16, 26 and fourth 17, 27 zones of the first 10 and second 20 lenses comprise microlenses of 1 millimeter in diameter and a dioptric power between 1 and 10 diopters, preferably equal to 4 diopters. Each micro-optical element of the third 16, 26 and fourth 17, 27 zones of the first 10 and second 20 lenses is spaced from the adjacent micro-optical elements by at least 0.1 millimeter, typically by 1 millimeter edge to edge. The density of the arrangement of the micro-optical elements over the third 16, 26 and fourth 17, 27 zones of the first 10 and second 20 lenses is of 30 percent.

This embodiment also allows considering the dominant eye that may change according to the distance vision. Thus, the embodiment is configured to provide better visual acuity to the dominant eye according to the distance vision. As more zones are defined in the optical design of the first and second lens 10, 20, the correction as a function of the dominant eye is improved.

In a variant, it should be noted that the optical design of the first lens 10 of the pair of spectacle lenses disclosed by FIGS. 1-4 can be combined with the optical design of the second lens 20 of the pair of spectacle lenses disclosed by FIG. 10 as explained with FIGS. 5 and 6. In addition, the optical design of the first lens 10 of the pair of spectacle lenses disclosed by FIGS. 1-4 can be combined with the optical design of the second lens 20 of the pair of spectacle lenses disclosed by FIGS. 8-9 to form a fifth embodiment of a pair of spectacle lenses (not shown). Similarly, the optical design of the second lens 20 of the pair of spectacle lenses disclosed by FIGS. 1-4 can be combined with the optical design of the first lens of the pair of spectacle lenses disclosed by FIG. 8-9 or 10 to form a sixth embodiment of a pair of spectacle lenses (not shown).

Thus, it should be understood that any optical design of the first lens 10 disclosed in the present disclosure can be combined with any optical design of the second lens 20 disclosed in the present disclosure provided that the arrangement of micro-optical elements of the first lens is asymmetrical with the arrangement of micro-optical elements of the second lens.

In addition, the form of the lenses or zones are not limited to the examples shown on the drawings.

1. A pair of spectacle lenses for managing myopia progression comprising a first optical lens intended to be worn in front of a first eye of a wearer and a second optical lens intended to be worn in front of a second eye of the wearer, in which:
the first optical lens comprises an arrangement of micro-optical elements, and
the second optical lens comprises an arrangement of micro-optical elements,
wherein the arrangement of the micro-optical elements of the first optical lens and the arrangement of the micro-optical elements of the second optical lens are asymmetrical relatively to a sagittal plane of the pair of the spectacle lenses.

2. The pair of spectacle lenses according to claim 1, wherein the arrangement of the micro-optical elements of the first optical lens differs from the arrangement of the micro-optical elements of the second optical lens by at least one of the following features:
density of the micro-optical elements;
dioptric power of the micro-optical elements;
geometry of the micro-optical elements;
refractive, diffractive or diffusive optical function of the micro-optical elements;
focal length of the micro-optical elements;
diameter of the micro-optical elements;
position of the arrangement of the micro-optical elements in a visual field of the first optical lens and of the second optical lens;
position of the micro-optical elements in the arrangement of the micro-optical elements.

3. The pair of spectacle lenses according to claim 1, wherein at least one of the first and second optical lenses comprises a central zone with micro-optical elements.

4. The pair of spectacle lenses according to claim 1, wherein at least one of the first and second optical lenses comprises a central zone without any micro-optical element.

5. The pair of spectacle lenses according to claim 3, wherein the arrangement of micro-optical elements of at least one of the first and second optical lenses comprises at least one arc of circle centered on the central zone.

6. The pair of spectacle lenses according to claim 3, wherein the first optical lens and the second optical lens are each divided in at least three complementary zones, the central zone, a first zone and a second zone, the arrangement of the micro-optical elements of the first zone of the first optical lens differing from the arrangement of the micro-optical elements of the second zone of the first optical lens and the arrangement of the micro-optical elements of the first zone of the second optical lens differing from the arrangement of the micro-optical elements of the second zone of the second optical lens, the arrangement of the micro-optical elements in first zone of the first optical lens being symmetric with the arrangement of the micro-optical elements in the first zone of the second optical lens by rotation of 180 degrees about an axis passing through the sagittal plane and perpendicular to a mean plane of the pair of spectacle lenses.

7. The pair of spectacle lenses according to claim 3, wherein the first optical lens and the second optical lens are each divided in five complementary zones, the central zone, and four quadrants at 45 degrees defining respectively first, second, third and fourth zones, the arrangement of the micro-optical elements of the first zone of the first optical lens differing from the arrangement of the micro-optical elements of the second, third and fourth zones of the first optical lens and the arrangement the micro-optical elements of the first zone of the second optical lens differing from the arrangement of the micro-optical elements of the second, third and fourth zones of the second optical lens, the arrangements of the micro-optical elements in the first and second zones of the first optical lens being symmetric with the respective arrangements of the micro-optical elements in the first and second zones of the second lens by rotation of 180 degrees about an axis passing through the sagittal plane and perpendicular to a mean plane of the pair of spectacle lenses.

8. The pair of spectacle lenses according to claim 7, wherein the arrangement of the micro-optical elements of the second zone of the first optical lens differs from the arrangement of the micro-optical elements of the third and fourth zones of the first optical lens, and the arrangement of the micro-optical elements of the second zone of the second optical lens differs from the arrangement of the micro-optical elements of the third and fourth zones of the second optical lens.

9. The pair of spectacle lenses according to claim 7, wherein the arrangement of the micro-optical elements of the third zone of the first optical lens is similar to the arrangement of the micro-optical elements of the fourth zone of the first optical lens and the arrangement of the micro-optical elements of the third zone of the second optical lens is similar to the arrangement of the micro-optical elements of the fourth zone of the second optical lens.

10. The pair of spectacle lenses according to claim 1, wherein the micro-optical elements of at least one of the first and second optical lenses are contiguous.

11. The pair of spectacle lenses according to claim 1, wherein the arrangements of the micro-optical elements of the optical lenses are configured such that the first optical lens and the second optical lens each complies to an optical criterion based on the Modulation Transfer Function, said optical criterion of the first optical lens differing from the optical criterion of the second optical lens.

12. The pair of spectacle lenses according to claim 11, wherein the first optical lens and second optical lens comprising each an optical axis and horizontal and vertical axis both transverse to the optical axis, at least one optical criterion of the optical criteria of the first optical lens and second optical lens presents a variation along the horizontal axis and a variation along the vertical axis, said variation along the vertical axis differing from the variation along the horizontal axis.

13. The pair of spectacle lenses according to claim 1, wherein the arrangement of the micro-optical elements of the first and second optical lenses are adapted based on the dominant eye of the wearer.

14. The pair of spectacle lenses according to claim 1, wherein at least one of the optical lenses has at least one prescribed refractive power to provide a dioptric correction for the eye of the wearer.

15. The vision compensation spectacles for managing myopia progression comprising a frame and a pair of spectacle lenses according to claim 1.
